(19) United States
(12) Patent Application Publication
(10) Pub. No.: US 2015/0301597 A1
(43) Pub. Date: Oct. 22, 2015

(54) CALCULATION OF AN ANALYTICAL TRAIL IN BEHAVIORAL RESEARCH

(71) Applicant: 2020 IP, LLC, Nashville, TN (US)

(72) Inventors: Isaac David ROGERS, Nashville, TN (US); James Edward BRYSON, Nashville, TN (US); Kathryn Kersey HARLAN, Nashville, TN (US)

(21) Appl. No.: 14/466,643

(22) Filed: Aug. 22, 2014

Related U.S. Application Data
(63) Continuation-in-part of application No. 14/254,643, filed on Apr. 16, 2014.

(51) Int. Cl. G06F 3/01; G06K 9/00

(52) U.S. Cl. CPC G06F 3/013; G06K 9/0061; G06K 9/00604; G06K 9/00335

(57) ABSTRACT

Exemplary embodiments provide methods, mediums, and systems for behavioral research. In some embodiments, a simulated environment may be created and displayed. A user may interact with the simulated environment by directing the user's gaze towards different objects in the simulated environment. One or more gaze fields may be calculated to determine which objects the user is viewing. A score may be calculated for the objects in the simulated environment, and the score may be used to display an analytical trail. The score may be dependent on both a first look at an object, in which the user first directs their gaze toward the object, and one or more second looks at the object, in which the user looks away from the object and then returns their gaze to the object. In determining the score, the second looks may be given more weight than the first look.

### RELATED APPLICATIONS

The present application is a continuation-in-part of, and claims priority to, U.S. patent application Ser. No. 14/254,643, entitled “Systems and Methods for Multi-User Behavioral Research” and filed on Apr. 16, 2014. The contents of the aforementioned application are incorporated herein by reference.

### BACKGROUND

In performing behavioral research, such as product preference evaluation, current technologies provide only limited insight into a user's behavior. For example, some behavioral researchers use eye tracking equipment to determine where a user is currently looking. These systems typically register a precise location that is considered to be the point at which the user is directing their gaze. This can be problematic, because a user may register interest in a product even when they are not looking directly at the product. For example, a user might be attracted to the packaging of two different products and might center their gaze somewhere between the products. A conventional system might register this as giving interest to the central location, rather than to the two products.

Conventional systems may further treat all eye location data as being equal. Thus, if a user looks at Product A for a certain amount of time and Product B for the same amount of time, a conventional system may register this as representing an equal amount of interest in Products A and B. However, this may or may not be the case. If, for example, a user looks at Product A for five seconds before moving on to a new product, this may indicate some initial interest in Product A. However, if the user glances at Product B briefly (e.g., 0.5 seconds) and then looks at several other products, only to later return to Product B and spend more time looking at the product (e.g., 4.5 seconds), this may indicate that the user remembered Product B from among all the products on the shelf and was interested enough in the product to return to it later. Even though the user spent 5 seconds looking at each of Products A and B, it is likely that Product B created a stronger impression. Unfortunately, conventional eye-tracking systems may not register this stronger impression.

The present application is addressed to these and other issues that may constrain conventional behavioral research and consumer preference testing.

### SUMMARY

Exemplary embodiments described herein relate to methods, mediums, and systems for performing behavioral research in a simulated environment, such as a virtual reality environment.

According to an exemplary embodiment, a representation of a simulated environment that includes a plurality of objects of interest may be stored and accessed. A user may be placed in the simulated environment and allowed to interact with the simulated environment (e.g., using a display device and/or virtual reality headset).

While interacting with the simulated environment, a processor of a device (e.g., the virtual reality headset or a remote server receiving data from the simulated environment) may register the user's gaze location within the simulated environment. Registering the gaze location may involve, for example, calculating a gaze box (rather than using a fixed point) which is centered on a location in which the display device is pointed in the simulated environment. Moreover, multiple gaze boxes may be calculated. The gaze boxes may extend concentrically from the location in which the display device is pointed in the simulated environment. Each gaze box may represent a certain area of the user's field of vision, each gaze box moving progressively further from the center of the user's field of view.

The processor may recognize that a target object is within the gaze location. The processor may calculate a first score for the target object in response to the target object being within the gaze location. For example, the processor may measure the length of time that the target object is present within the gaze location (e.g., the gaze box) and may assign a score to the target object based on the measured amount of time. In embodiments employing multiple gaze boxes, each gaze box may be assigned a different scoring system or multiplier, which may allow (for example) more points to be assigned to objects that are closer to the user's center of vision.

The processor may further recognize that the gaze location moves away from the target object and then returns to the target object. The processor may impose a minimum amount of time away from the target object before the processor recognizes that the gaze location has moved away from the target object and then back to the target object.

In response to the target returning to the gaze location, the processor may calculate a second score for the target object. The second score may be based on an amount of time that the gaze location remains on the target object after returning to the target object.

Using the first score and the second score, the processor may calculate an overall score for the target object. In calculating the overall score, the second score may be weighted more than the first score.

In some embodiments employing multiple gaze boxes, either or both of calculating the first score or calculating the second score may involve assigning scores to objects in the gaze boxes. Gaze boxes further from the location in which the display device is pointed in the simulated environment may receive lower scores than gaze boxes closer to the location in which the display device is pointed in the simulated environment.

After calculating the overall score, the score may be displayed on the simulated environment as an analytical trail. This may involve displaying the simulated environment on a display device, and visually distinguishing the plurality of objects in the simulated environment based on the respectively calculated overall scores for the plurality of objects. For example, the analytical trail may be color coded (among other possibilities) such that objects with higher overall scores are displayed in different (e.g., brighter) colors than objects with lower overall scores. The analytical trail may make it simple for a moderator or client to visualize which objects/products received the most attention. In some case, individual users' overall scores may be aggregated in order to create the analytical trail.

Using the exemplary embodiments described herein, behavioral research can be carried out in an efficient, inexpensive, and reliable manner. These and other features of exemplary embodiments will be apparent from the detailed description below, and the accompanying Figures.

### BRIEF DESCRIPTION OF THE DRAWINGS

FIG. 1 depicts an exemplary system for hosting, managing, and displaying a simulated environment according to an exemplary embodiment.

FIGS. 2A-2C depict examples of different simulated environments.

FIG. 3A-3D depict views of an exemplary simulated environment.

FIGS. 3E-3F depict examples of split tests in the simulated environment.

FIG. 4 depicts exemplary data representative of different types of users and interfaces.

FIGS. 5A-5B depict exemplary embodiments in which one or more participants interact with the simulated environment.

FIG. 6 depicts an exemplary format for objects and triggers suitable for use in exemplary simulated environments.

FIG. 7 depicts a hardware-agnostic canvas suitable for use in exemplary embodiments

FIG. 8 is a flowchart describing an exemplary method for building a hardware-agnostic canvas representing a simulated environment.

FIG. 9 is a flowchart describing an exemplary method for translating a hardware-agnostic canvas into viewer-specific code suitable for use on exemplary environment viewers.

FIG. 10 is a data flow diagram showing exemplary information-routing paths for displaying and managing the simulated environment.

FIG. 11A is a flowchart describing an exemplary method for interacting with the simulated environment through a participant interface.

FIGS. 11B-11F depict exemplary interfaces for interacting with the simulated environment.

FIG. 12 describes an exemplary method for gathering and aggregating data from participants in the simulated environment.

FIGS. 13A-13B depict examples of capturing gaze data in the simulated environment.

FIG. 13C depicts a map of aggregated data superimposed on the simulated environment.

FIGS. 13D-13F depict examples of playing back a user experience in the simulated environment through a moderator interface.

FIG. 14 is a flowchart describing an exemplary method for calculating overall object scores based on user gaze data

FIG. 15 depicts an exemplary electronic device suitable for use with exemplary embodiments.

### DETAILED DESCRIPTION

Exemplary embodiments relate to methods, mediums, and systems for conducting behavioral research in a simulated environment. One or more devices may work together to maintain the simulated environment and analyze data indicative of where a user is placing their attention within the environment. In order to conduct the research, multiple different types of users, including participants, moderators, and clients, may interact with the simulated environment. Exemplary embodiments provide different interfaces having different capabilities for each of the different types of users.

As used herein, a participant refers to a person whose behavior is being monitored or observed in a behavioral research project. The participant may be placed into a simulated environment and allowed to freely or semi-freely interact with the environment, changing the location of their gaze within the environment. The participant's gaze location may be analyzed to determine which objects in the simulated environment are more likely to capture a consumer's attention.

The simulated environment and the participant(s)′ interactions with the environment may be curated by a moderator. As used herein, a “moderator” refers to an entity or entities that interactively guide the participant's experience in the simulated environment. This interaction may include audio, visual and/or haptic cues. The interaction may involve directing the participant's attention to particular features within the simulated environment, posing questions to the participant, and manually moving the participant within the simulated environment.

A “client” may have an interest in the participant's views of the objects in the simulated environment. For example, the client may be a product designer whose products are being tested in the simulated environment. However, it may be undesirable to allow the client to directly interact with the participant, as this may affect the impartiality of the participant's observations. Accordingly, in some embodiments a client is limited to passive observation: e.g., viewing the simulated environment from the perspective of the participant. In other embodiments, the client may be permitted limited interaction with the participant, such as by triggering survey questions.

Participants, moderators, and clients are collectively referred to herein as users. One or more different types of interfaces may be defined for allowing the different types of users to connect to, and interact with, the simulated environment. Each of the different types of interfaces may support a different type of user by providing the above-described functionality for a user connecting to the interface. For example, a participant interface may allow a user connecting through it to move about the simulated environment, change the location of their gaze, and receive and answer survey questions about objects in the environment. The participant interface may lack the ability to (for example) manually trigger survey questions or change the location of other participants, which may be capabilities reserved for the moderator interface.

An overview of the system for providing the simulated environment will first be described.

### System Overview

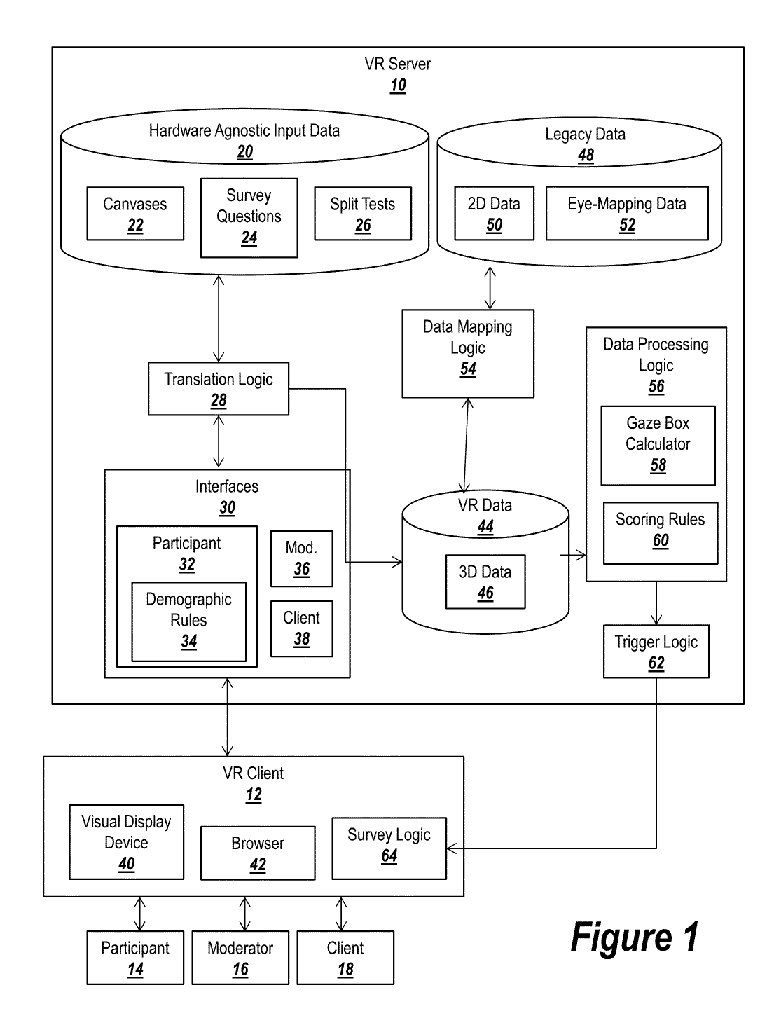

FIG. 1 depicts an exemplary system for supporting the different types of users in a simulated environment.

The system may include a virtual reality (VR) server 10 and a VR client 12. The VR server 10 may be responsible for maintaining a simulated environment and coordinating the use of the simulated environment among multiple users. The users, which may include a participant 14, a moderator 16, and a client 18, may interact with the simulated environment through one or more VR clients 12.

The simulated environment may be displayed on a visual display device 40, such as a VR headset. Visual display devices 40 come in multiple different types, some of which may use proprietary or custom display formats. Examples of visual display devices 40 include, but are not limited to, the Oculus Rift headset of Facebook, Inc. of Menlo Park, Calif. and the Project Morpheus headset produced by Sony Corp. of Tokyo, Japan.

Because each of the different types of VR headsets may use unique display formats, it may be desirable to store information used to create the simulated environment in a hardware agnostic manner. Thus, the VR server 10 may store hardware agnostic input data 20. In this regards, “hardware agnostic” refers to a neutral format that is not specific to, or usable by, a single particular type of device. Rather, the hardware agnostic input data 20 is saved in a format that is readily translated into a format that can be understood by a particular hardware device. In other embodiments, input data used to create the simulated environment may be stored in an proprietary or hardware non-agnostic format, and then translated into other formats as necessary (potentially by translating the input data from a first hardware-specific format into an intermediate hardware agnostic format, and then from the hardware agnostic format into a second hardware-specific format).

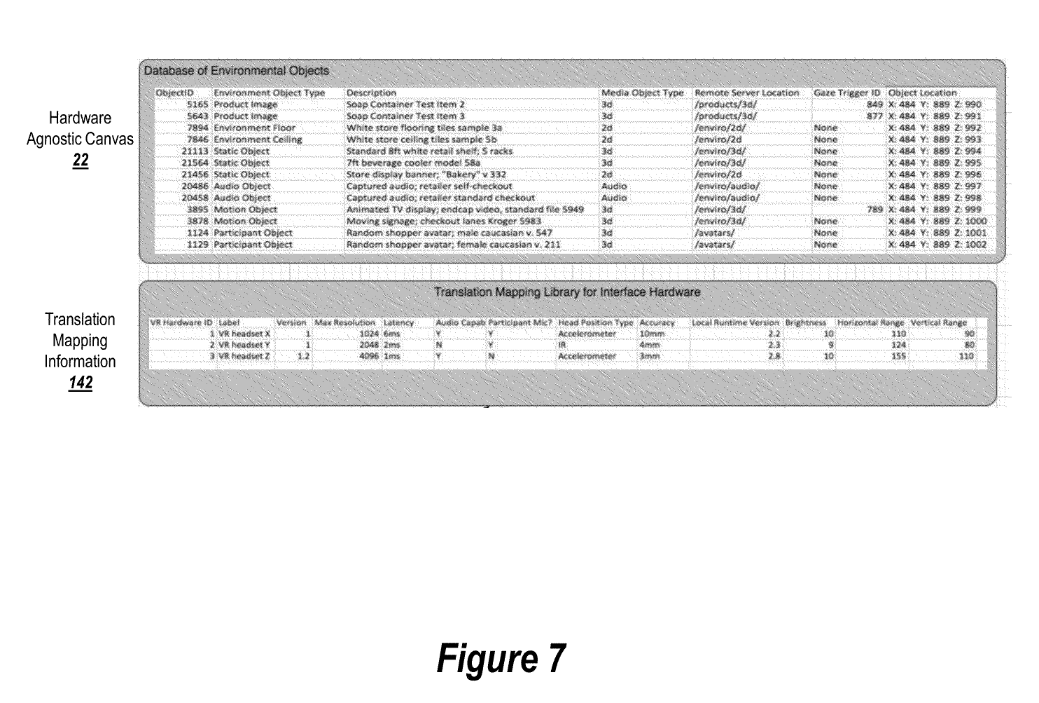

The hardware agnostic input data 20 may include hardware agnostic canvases 22 that represent the simulated environment and the objects in it. For example, the canvases 22 may represent databases of stored objects and locations for the stored objects, which are rendered in the simulated environment. The hardware agnostic canvases may define a location for the objects in a 3D or 2D coordinate system, which can be used by the VR client 12 to render the objects at an appropriate location with respect to the user's position in the simulated environment. An example of a hardware agnostic canvas is depicted in FIG. 7 and discussed in more detail below.

The hardware agnostic input data 20 may further include survey questions 24. The survey questions 24 may include questions that are triggered, either manually (e.g., by a moderator) or when a certain set of conditions with respect to the user, the environment, and/or an object in the environment are met. For example, the survey questions 24 may define a trigger location at which the question may be triggered.

The survey questions 24 may further define an attention score required before the questions are triggered. As will be described in more detail below, the VR server 10 may calculate a score for one or more objects or locations in the simulated environment based on how much attention a participant gives to the object or location. For example, a participant that stared at an object for ten seconds might yield a higher score for the object than a participant who glances at the object in passing. The score may be accumulated by increasing amounts if the participant re-visits an object (e.g., the participant glances at the object, moves away from the object for a certain period of time, and then returns to the object).

By using the attention score to trigger questions, different questions can be posed to a participant depending on how much attention the participant has given to the object. For instance, exemplary survey questions 24 are shown in Table 1 below. In Table 1, each of the four questions is triggered at the same location. However, depending on how much attention score the user has accumulated for the object at that location, different questions may be posed.

TABLE 1
Exemplary Survey Questions

| Ques- | | | | Score Re- |
|---|---|---|---|---|
| tion | | | | quired on |
| ID | Question | Responses | Trigger Location | Location |
| 1 | What do you think | Voice audio | (21.8, 77.2, 99.2) | 2300 |
| | of this package? | response | | |
| | | (max 30 sec) | | |
| 2 | Did you notice the | Yes/No | (21.8, 77.2, 99.2) | 1000 |
| | price? | | | |
| 3 | Have you seen this | Yes/No/ | (21.8, 77.2, 99.2) | 5000 |
| | product before? | Don't Recall | | |
| 4 | What was the name | Open Text | (21.8, 77.2, 99.2) | 2000 |
| | of this product? | | | |

In addition to the canvases 22 and the survey questions 24, the hardware agnostic input data 20 may include split tests 26, which define variants of a product that may be tested in the simulated environment. For example, a split test 26 may define two different types of packaging that may be applied to a product. The different types of packaging may be displayed randomly to different participants, or may be displayed based on participant demographics (e.g., men view a product in green packaging, whereas women view a product in yellow packaging).

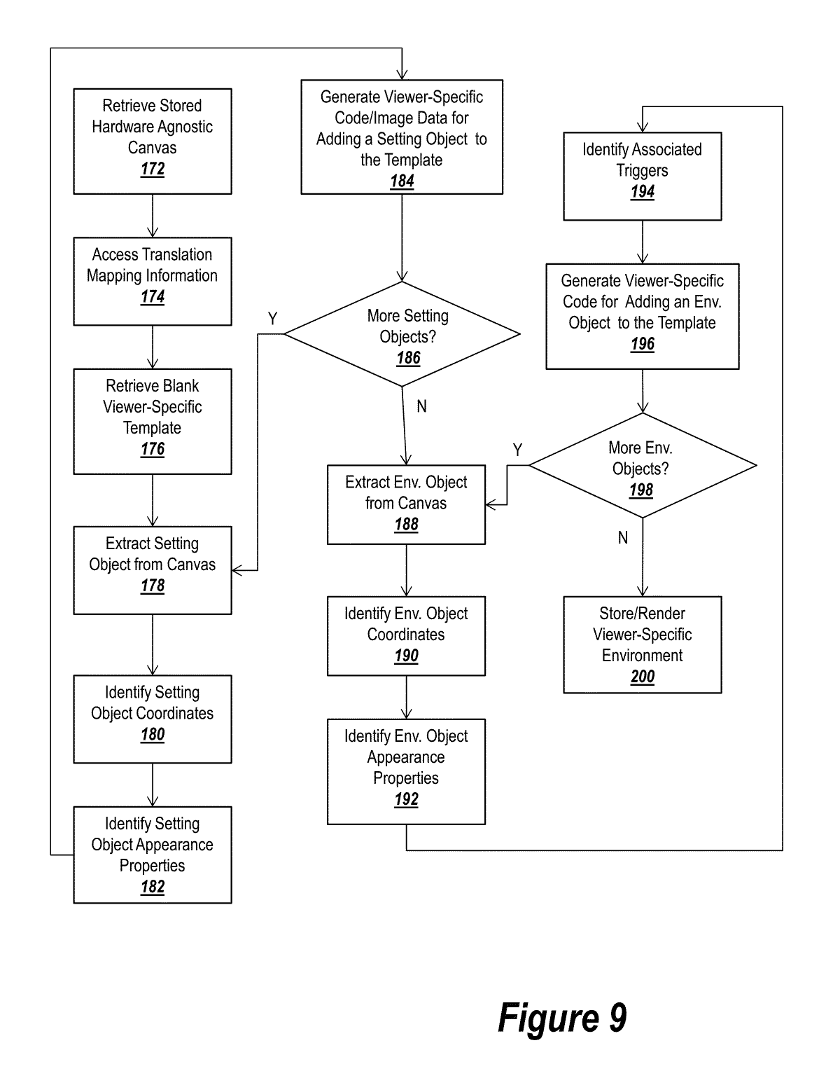

The hardware agnostic input data 20 may be translated into a format understandable by the VR client 12 by translation logic 28. Among other functionality, the translation logic may accept the object definitions in the canvases 22, which are defined using a coordinate system, and provide instructions for the VR client that allows the VR client to accurately render the objects. The translation logic may account for (among other things) the resolution, color capabilities, and size of the visual display device 40 in determining how the object should be rendered in the simulated environment on that particular visual display device 40. An exemplary method for translating the hardware agnostic input data 20, which may be implemented by the translation logic 28, is described in more detail with respect to FIG. 9.

The translation logic 28 may also work in reverse. That is, the translation logic 28 may accept data (2D or 3D data) returned from the VR client 12 and translate the data into a hardware agnostic format for processing. For instance, the VR client 12 may provide information as to where the display was pointing at a particular moment in time. The translation logic may accept this information and determine the participant's location and/or the direction in which the participant was looking with respect to the hardware-agnostic coordinate system. This information may be used for data processing and aggregation across multiple users (potentially using multiple different types of visual display devices 40).

Once the hardware agnostic input data 20 is translated by the translation logic 28, it may be used to generate a simulated environment. Because each of the participant(s) 14, the moderator(s) 16, and the client(s) 18 interact with the simulated environment in different ways, different types of interfaces 30 into the VR server may be provided. By accessing a particular type of interface 30, the user defines what type of user they are and what kinds of capabilities they will have to interact with the environment and other users in the environment.

For example, a participant interface 32 may send and receive instructions for simulating an environment and observing the simulated environment. The participant interface 32 may allow a participant 14 to change their position (e.g., the position of a participant avatar) in the simulated environment. The participant interface 32 may further allow the participant 14 to change a location of the participant's 14 gaze in the simulated environment.

The participant interface 32 may include demographic rules 34 that cause the environment to be simulated in a different manner depending on demographic attributes of the participant 14. For example, different products may be displayed to participants 14 having different demographic attributes, or the participant 14 could be placed in an entirely different simulated environment depending on their demographic attributes.

The interfaces 30 may further include a moderator interface 36 that sends and receives instructions for simulating the environment and manipulating the simulated environment. The moderator interface 36 may allow the moderator 16 to interact with the simulated environment using their own avatar (e.g., the moderator 16 may move through the simulated environment in the same manner as a participant 14), or may allow the moderator 16 to view the simulated environment from the perspective of one of the participants 14 (e.g., viewing the environment through the eyes of the participant). The moderator interface 30 may include a switch or selection mechanism that allows the moderator 16 to switch the moderator's view from a moderator avatar to a participant's perspective. The switch or selection mechanism may be activated during a research session in order to allow for real-time switching between perspectives.

The moderator interface 36 may allow a moderator 16 to move a selected participant 14 to a specified location in the simulated environment. The moderator interface 36 may further include logic for manually triggering a survey question.

The interfaces 30 may further include a client interface 38 that sends and receives instructions for viewing the simulated environment from the perspective of the participant 14. In some embodiments, the client interface 38 may limit the actions of the client 18 in the simulated environment to viewing the simulated environment from the perspective of the participant 14. In others, the client 18 may be provided with some limited ability to interact with the participant 14 (e.g., by triggering survey questions 24).

The interfaces 30 may be implemented in a number of ways. For example, the VR server 10 may expose different ports through which different types of users may connect over a network. A user connecting through port 1 may be identified as a participant 14, a user connecting through port 2 may be identified as a moderator 16, and a user connecting through port 3 may be identified as a client 18.

Alternatively or in addition, the interfaces 30 may define different packet formats (e.g., a first format for a participant 14, a second format for a moderator 16, and a third format for a client 18). When a packet is received by the interfaces 30, the interfaces 30 may identify the packet format, determine what type of user is associated with the format, and provide appropriate functionality.

Alternatively or in addition, instructions from the VR client 12 may be tagged with different flags depending on what type of user is interacting with the VR client 12. The interfaces 30 may recognize the flags and provide different types of functionality according to what type of user is associated with each flag.

Still further, the interfaces 30 may be programmed with a library of users and a type associated with each user. When instructions or information is received from a particular user (e.g., tagged by a user ID), the interfaces 30 may consult the library and determine what functionality the user is able to implement.

Providing the different types of functionality to different types of users may be achieved in several ways. The different types of interfaces 30 may interpret commands differently depending on what type of interface 30 the command is received on. Furthermore, the interfaces 30 may instruct the visual display device 40 to provide different displays, graphical interfaces, and or menu options depending on which type of interface the user connects through.

For example, a user connecting through the participant interface 32 may be provided with the functionality to move their avatar through the simulated environment. If the user is interacting with the environment using (e.g.) a joystick, then commands from the joystick may be interpreted as a command to move an avatar present in the simulated environment according to the joystick commands. On the other hand, a moderator 16 may or may not be in control of an avatar. If the moderator 16 is not controlling an avatar, and is instead observing the simulated environment from a camera perspective or “bird's eye view,” then the joystick commands received through the moderator interface 36 may be interpreted as a command to move the moderator's 16 camera. Still further, joystick commands from a client 18 may be interpreted as an instruction to change the participant 14 whose perspective the client 18 is currently observing.

In another example, a participant 14 may be presented with a view of the simulated environment through the visual display device 40. The view may include a window for presenting survey questions 24, when the survey questions 24 are triggered. The participant interface 32 may transmit instructions for displaying such an interface on the participant's 14 visual display device 40.

In contrast, the moderator 14 may be provided with a display of the simulated environment, but may also be provided with administrative menu options. The menu options might include, for example, a command to move a user to a specified location, an “enable communication” command that allows the moderator to transmit audio signals to the VR client 12 of a participant 14, a command to manually trigger a survey question 24, etc.

Similarly, the client 18 may be provided with interface options for changing perspective to a different participant 14, triggering survey questions, etc.

Thus, the interfaces 30 may include instructions for rendering different types of displays and different types of display options depending on what kind of user has accessed the interface.

The simulated environment as viewed through the interfaces 30 may be displayed on the visual display device 40 and/or a browser 42 of the VR client 12. The browser 42 may be, for example, a two-dimensional representation of the simulated environment (e.g., a representation viewed on a web browser or a 2D gaming console).

As the participant 14 interacts with the simulated environment through the VR client 12, the VR client 12 may generate VR data 44 describing the participant's 14 interaction with the environment. In one exemplary embodiment, the VR client 12 may collect data regarding the location of the participant's 14 avatar in the simulated environment, and the location at which the participant 14 is directing their gaze.

The location of the participant's 14 avatar may be determined, for example, based on relative movement data. The participant's 14 avatar may be initially placed at a known location (or, during the course of the simulation, may be moved to a known location). The participant 14 may be provided with the capability of moving their avatar, for example through the use of keyboard input, a joystick, body movements, etc. The instructions for moving the avatar may be transmitted to the VR server 10 or may be executed locally at the VR client 12. Based on the instructions, an updated location for the participant's 14 avatar in the simulated environment may be determined, and an updated view of the environment may be rendered. The location of the participant's 14 avatar may be recorded at the VR server 10 as 3D data 46. The location may be recorded each time the avatar location changes, or may be sampled at regular intervals.

Exemplary location data is shown in Table 2, below:

TABLE 2
Exemplary Location Data

| User ID | Project ID | Arena ID | Timestamp | Location |
|---|---|---|---|---|
| 123456 | 987 | 859 | 12:01:01 | (21.6, 77.2, 99.2) |
| 123456 | 987 | 859 | 12:01:02 | (21.6, 77.2, 99.2) |
| 123456 | 987 | 859 | 12:01:03 | (22.7, 74.2, 99.2) |
| 123456 | 987 | 859 | 12:01:04 | (19.1, 73.2, 99.2) |

In addition to the location data, the system may record information about the direction of the participant's 14 gaze. The direction of the participant's 14 gaze may be determined directly, indirectly, and/or may be imputed.

The participant's 14 gaze location may be determined directly, for example, by tracking the movement of the participant's 14 eyes using eye tracking hardware. The eye tracking hardware may be present in the visual display device 40, or may be provided separately.

The participant's 14 gaze location may be indirectly determined by measuring a variable that is correlated to eye movement. For example, in a virtual reality environment, a user may change their perspective by turning their head. In this case, it may be assumed that the user is primarily directing their attention to the center of the display field. If the user wishes to see something in their periphery, the user will likely turn their head in that direction. Accordingly, The participant's 14 gaze location may be estimated to be the center of the display field of the visual display device 40.

Alternatively or in addition, the participant's 14 gaze location may be imputed using logic that analyzes the user's behavior. For example, if the participant 14 interacts with the simulated environment by clicking in a browser 42, the location of the participant's 14 clicks may be used as a proxy for the location at which the participant 14 has placed their attention. Alternatively, a survey question may be presented directly asking the user where they have placed their attention. The survey responses may be analyzed to impute the user's behavior.

Exemplary gaze data is shown in Table 3, below:

TABLE 3
Exemplary Gaze Data

| User ID | Project ID | Arena ID | Timestamp | Center Gaze Location |
|---|---|---|---|---|
| 123456 | 987 | 859 | 12:01:01 | (21.6, 77.2, 99.2) |
| 123456 | 987 | 859 | 12:01:02 | (21.6, 77.2, 99.2) |
| 123456 | 987 | 859 | 12:01:03 | (22.7, 74.2, 99.2) |
| 123456 | 987 | 859 | 12:01:04 | (19.1, 73.2, 99.2) |

Once the location and gaze information are collected as VR data 44, the VR data may optionally be translated into, or combined with, legacy data 48. For example, 2D data (such as mouse clicks or hover times over a 2D canvas) and eye-mapping data 52 (representing the results of eye mapping studies) may be existent in the VR server 10. This data may have been previously analyzed to determine consumer preferences, and this preference information may be correlated with the new VR data 44 in order to avoid the duplication of existent work. Data mapping logic 54 may translate the VR data 44 into legacy data 48 and/or vice versa.

The VR data 44 may be processed by data processing logic 56 to evaluate where the participant 14 has directed their attention. The data processing logic may include, for example, a gaze box calculator 58 and scoring rules 60.

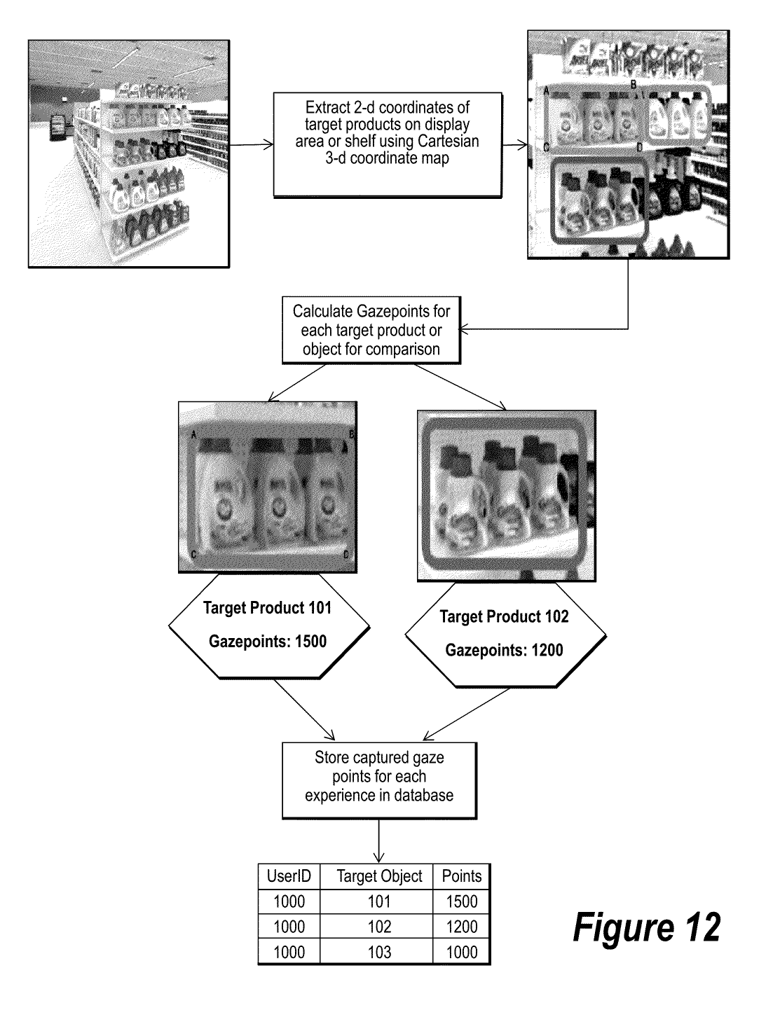

The gaze box calculator 58 may analyze the location data to determine where the user's gaze was directed (i.e., what part of the simulated environment the user looked at). The gaze box calculator 58 may calculate one or more areas in the participant's 14 view and use the scoring rules 60 to assign a score to each area, depending on the amount of attention the participant 14 gave to the area or the likelihood that the participant 14 was looking at the identified area. The gaze box calculator 58 and scoring rules 60 are discussed in more detail with respect to FIG. 12 below.

Furthermore, the participant's 14 gaze location and/or location information may be provided to trigger logic 62. The trigger logic 62 may compare the participant's 14 gaze location or avatar location to a list of trigger points in the simulated environment. If the participant gazed at, or moved to, a trigger point, then the trigger logic 62 may trigger an action, such as the posing of a survey question 24 to the participant 14. For example, the trigger logic 62 may retrieve a survey question 24 from the hardware agnostic input data 20 and forward the survey question 24 to survey logic 64 located at the VR client 12. The survey logic 64 may cause the survey question 24 to be presented to the participant 14, for example by popping up a survey window in the participant's 14 field of view. Alternatively or in addition, the survey question may be presented using auditory cues (e.g., a recording of the question may be played on a speaker associated with the participant's 14 VR client 12).

Upon receiving the survey question 24, the participant 14 may indicate an answer to the survey question. The answer may be provided, for example, via keyboard input, through a microphone, or through a gesture (such as moving the participant's 14 head, which may be recognized by an accelerometer in the visual display device 40). The participant's 14 answers to the survey questions may be stored in the VR data 44 at the VR server 10.

Although FIG. 1 depicts particular entities in particular locations, one of ordinary skill in the art will understand that more, fewer, or different entities may be employed. Furthermore, the entities depicted may be provided in different locations. For example, although FIG. 1 depicts the translation logic 28 as being resident on the VR server 10, the translation logic 28 may alternatively be located at the VR client 12, so that the VR server 10 sends the hardware agnostic input data 20 to the VR client 12, and the VR client 12 performs the translation. Similarly, the trigger logic 62 and/or the data processing logic 56 may be located at the VR client 12, the survey logic 64 may be located at the VR server 10.

The entities depicted in FIG. 1 may also be split between the VR server 10 and the VR client 12. For example, some of the logic for implementing the interfaces 30 or the trigger logic 62 may be provided at the VR server 10, while the rest of the logic is provided at the VR client 12. Alternatively or in addition, some or all of the entities of FIG. 1 may be provided at an intermediate device distinct from the VR server 10 and the VR client 12.

Thus, the VR server(s) 10 and VR client(s) 12 may interoperate to provide a simulated environment and allow multiple different types of users to interact with the simulated environment in order to perform behavioral research. Examples of simulated environments are described next.

### Exemplary Simulated Environments

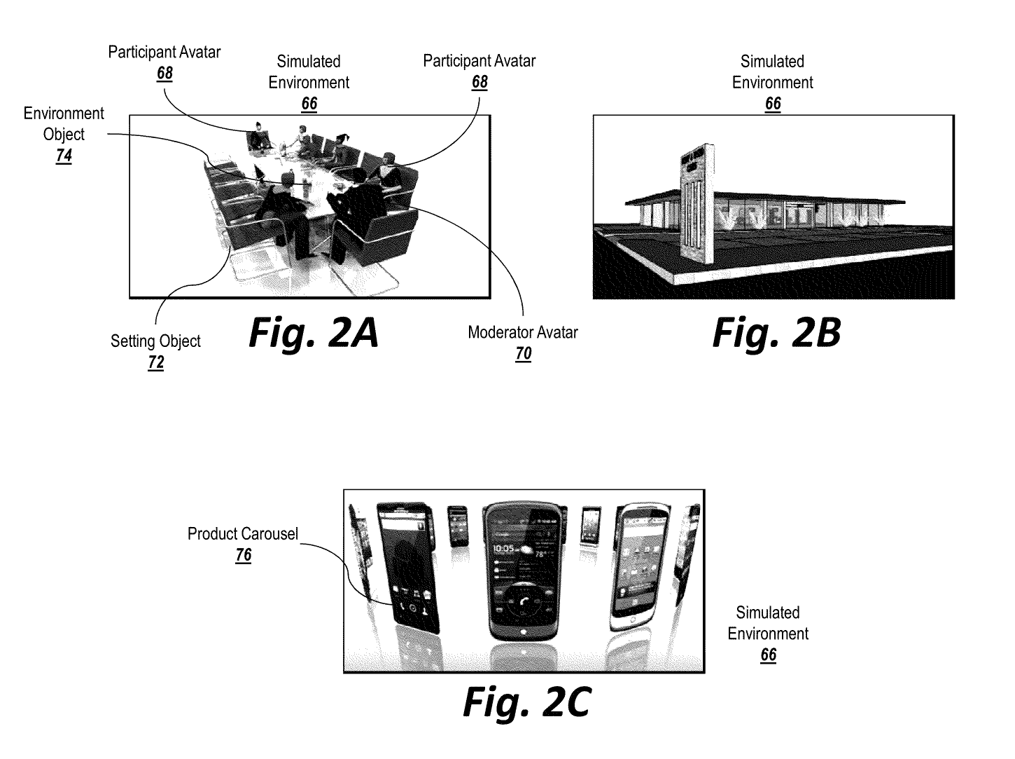

FIGS. 2A-2C depict examples of simulated environments 66 suitable for use with exemplary embodiments.

For example, FIG. 2A depicts a simulated environment 66 representing a focus group. Several participant avatars 68 are present in the simulated environment 66, as well as a moderator avatar 70. Each participant 14 may view the simulated environment 66 from the perspective of the participant's avatar 68, and the moderator may view the simulated environment 66 from the perspective of the moderator avatar 70.

In addition to the avatars 68, 70, the simulated environment 66 may be populated by one or more setting objects 72. Setting objects may represent objects placed in the simulated environment 66 in order to provide context or realism, such as table and chairs. Moreover, within the simulated environment 66, products may be presented for comparison. The products may be represented by objects placed in the simulated environment 66, referred to herein as environment objects 74.

The simulated focus group of FIG. 2A may allow products to be tested in a social or group setting, wherein the product is discussed among the participants 14. Other types of simulated environments are also possible. For example, FIG. 2B depicts an example of a simulated environment 66 representing a car dealership. Participant avatars may move through the simulated car dealership, observing products in their natural context.

Still further, FIG. 2C presents an example of a simulated environment 66 which includes a product carousel 76. Within the product carousel 76, different products (or different variations on the same product) may be viewed and moved between. A product carousel 76 may thus allow for a direct comparison between products or between different versions of a single product.

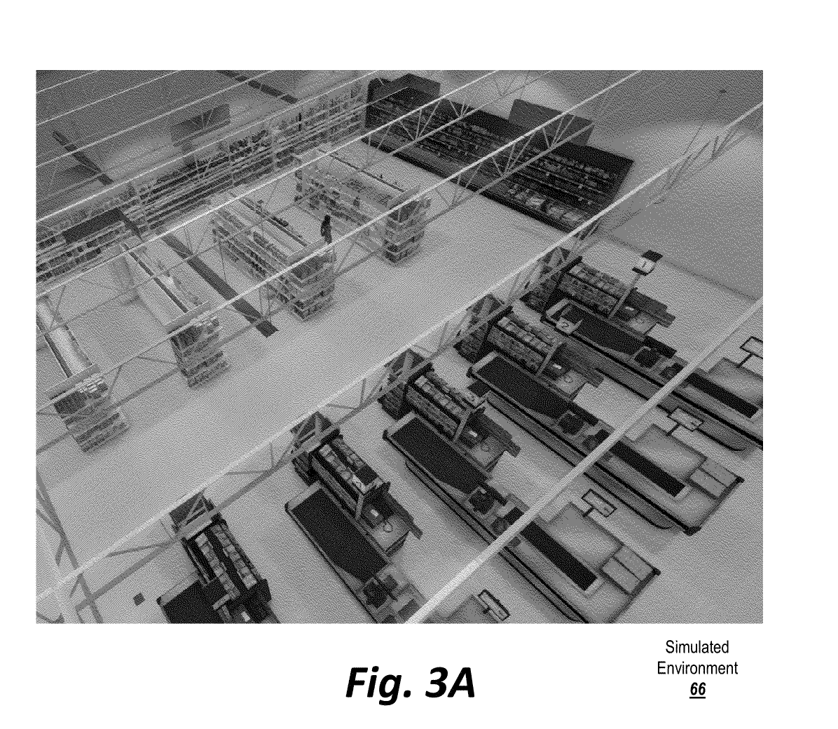

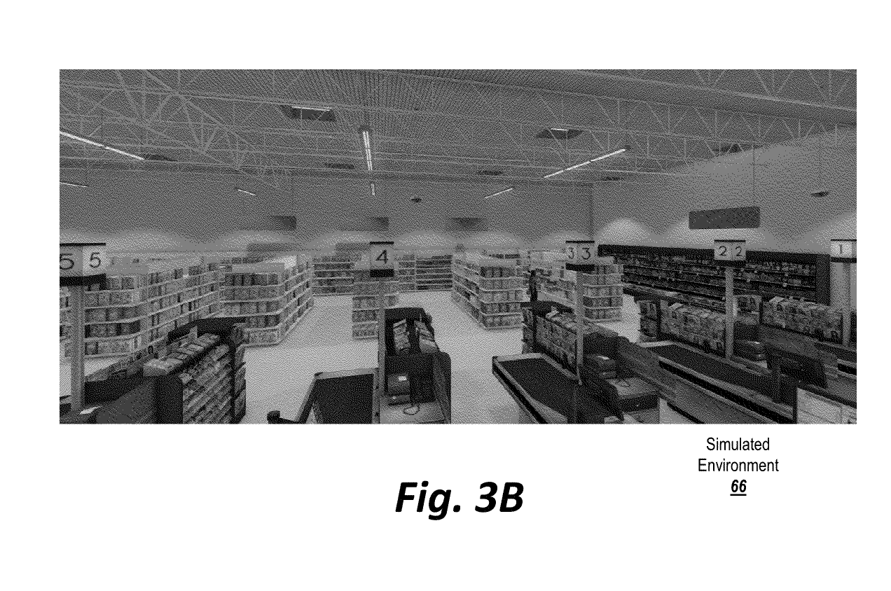

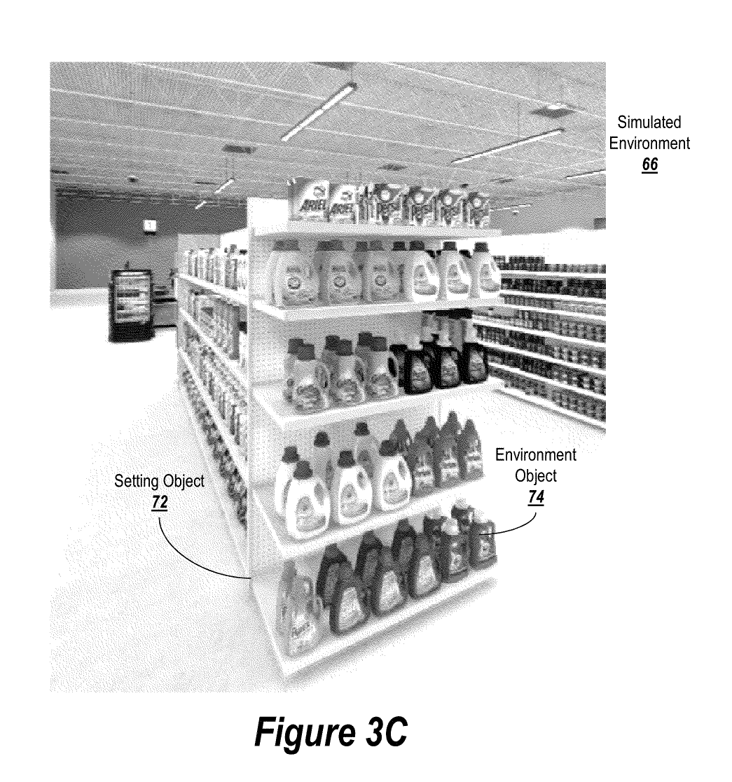

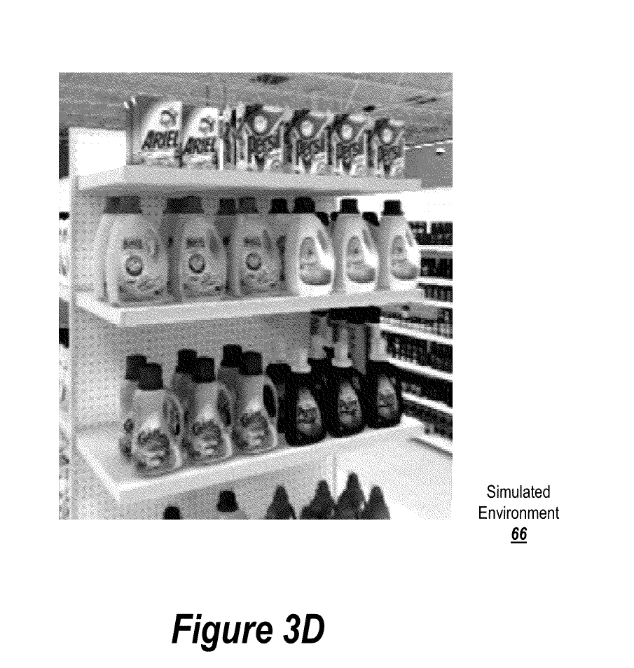

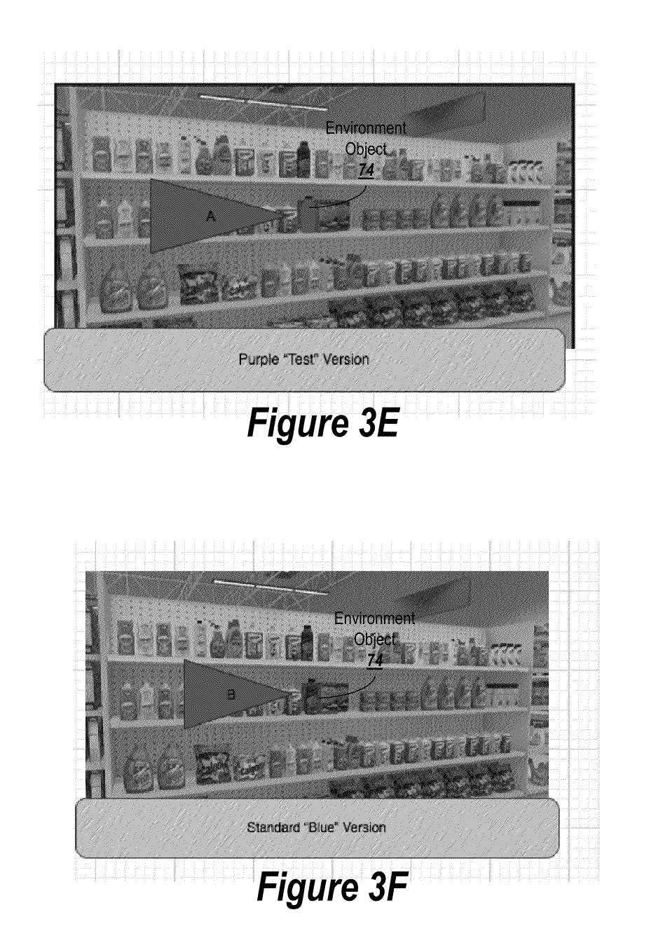

FIG. 3A-3D provide an in-depth example of a simulated environment 66. In this example, the simulated environment 66 represents a supermarket through which participant avatars can move. Products (represented by environment objects 74) may be placed on shelves (represented by setting objects 72).

FIG. 3A is an overhead view of the simulated environment 66, while FIG. 3B is a perspective view of the simulated environment 66. In the event that a moderator 16 or a client 18 are not viewing the simulated environment from the perspective of one of the participants 14 or from the perspective of their own avatars, the moderator 16 or the client 18 may be presented with an overhead or perspective view similar to the ones depicted in FIGS. 3A and 3B.

FIGS. 3C and 3D depict the simulated environment 66 as viewed from the perspective of an avatar, such as a participant avatar. FIGS. 3C and 3D provide a ground-level view of the simulated environment 66 as the user moves through the simulated environment 66, and are representative of what the user might see in the visual display device 40.

Within the simulated environment, “split tests” may be conducted in order to determine consumer preferences for different versions of products (e.g., different samples of product packaging). FIGS. 3E and 3F depict an example of a split test. In FIG. 3E, an environment object 74 is placed on a shelf at a particular location. In this example, the environment object 74 of FIG. 3E is a “test” version of the product having purple packaging, whereas the environment object 74 of FIG. 3F is a “standard” version of the product having blue packaging. Different “skins” representing different product packaging may be stored, for example, in the VR server 10 and retrieved as needed for display on individual VR clients 12. The different viewpoints depicted in FIGS. 3E and 3F may be seen by different participants in the simulated environment, or might be seen by the same participant at different times.

By recording the amount of attention paid to the different versions of the environment object 74 by different users across split tests, consumer preferences for different types of packaging may be determined. The different scores for the different products (calculated as described below) in a split test may be stored for future review by the moderator and/or client.

As noted above, the different types of users present in the simulated environment 66 may have different roles and/or capabilities. The VR server 10 may store different information for each of the different types of users in order to allow the users to effectively perform their roles. The stored information pertaining to each type of user may be collected through the respective interfaces, and is described in more detail below.

### User Data

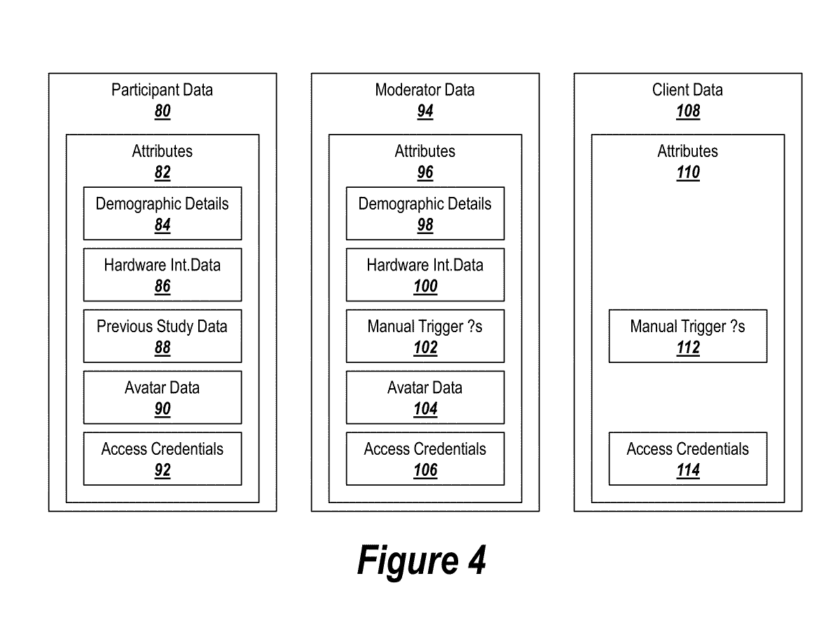

FIG. 4 depicts examples of the types of data that may be stored for each type of user.

For a participant 14, the VR server 10 may store participant data 80, which may include a number of attribute 82 of the participant. For example, the attributes 82 may include demographic details that describe the demographics of the participant. Exemplary demographic details are described in Table 4:

TABLE 4
Demographic Details

| Variable | Notes | Comment |
|---|---|---|
| Name | First/Last Name and/or Alias | |
| User ID | Serialized ID across system | Allows a single user to exist |
| | | across multiple environments |
| | | or projects |
| Contact | Email address, phone number, | Contact details for the user |
| | etc. | |
| Previous | Array of previous study | Used to calibrate experience |
| Studies | information | quotient |
| Age | | Used to calibrate experience |
| | | quotient |
| Total Ex- | Calculated value of total time | Used to calibrate experience |
| perience | in VR research environments | quotient |
| Time | | |
| General | Income, gender, race, ZIP | General background data used |
| Data | code, etc. | for profiling respondent |
| Social | Facebook ID, Twitter handle, | |
| Data | etc. | |

The attributes 82 may further include hardware interface data 86 describing the type of hardware (e.g. visual display device 40, browser 42, and/or VR client 12) used by the participant. Exemplary hardware interface data 86 is described in Table 5:

TABLE 5
Hardware Interface Data

| Variable | Notes | Comment |
|---|---|---|
| IP Address | Current logged in IP address | |
| Hardware | Virtual Reality headset device | Allows Virtual Reality |
| Profile | type, PC or gaming device | Experience to be |
| | information, profile data about | customized to the user's |
| | connected devices, etc. | headset or gaming unit |
| VR Ex- | List of current simulated | |
| perience | environments loaded on the | |
| Status | local device, including | |
| | percentage downloaded of | |
| | each | |
| VR Device | Current device statuses (e.g., | |
| Status | online, connected, | |
| | disconnected, high latency, | |
| | etc.) | |

The attributes 82 may further include previous study data 88 describing the results of previous behavioral studies performed by the participant through the VR server 10 and/or using traditional methods. Exemplary previous study data 88 is described in Table 6:

TABLE 6
Previous Study Data

| Variable | Notes | Comment |
|---|---|---|
| Previous | Array of previous studies | |
| Studies | completed in VR or using | |
| | traditional methods | |
| Study | Gaze Map converted results | Allows a user to synthetically |
| Results | from previous studies | replay previous study answers |
| | | in VR space |

The attributes 82 may further include avatar data 90 representing information used to generate the participant's avatar in the simulated environment. For example, the avatar data 90 may include image data used for rendering the participant's avatar, as well as other descriptive details (e.g., height, weight, gender, etc.).

The attributes 82 may further include access credentials that are used by the participant to access the VR server 10 and/or the simulated environment. Exemplary access credentials 92 are described in Table 7:

TABLE 7
Access Credentials

| | | |
|---|---|---|
| Variable | Notes | Comment |

| | |
|---|---|
| User ID | e.g., username or email |
| | address |
| Password | User or system created |
| | password |

Similarly to the participant 14, the moderator may 16 be associated with moderator data 94, which includes attributes 94 similar to the attributes of the participant. For example, the moderator data 94 may include demographic details 98, hardware interface data 100, avatar data 104, and access credentials 106 generally corresponding to those of the participant data 80.

The moderator data 94 may also include manual trigger questions 102, which may include survey questions that the moderator may cause to be asked of some or all participants at any time. In some embodiments, the manual trigger questions 102 may be displayed on a heads up display (HUD) of the moderator, so that the moderator may ask the participants the manual trigger questions (e.g., through a microphone and speaker).

The client 18 may be associated with client data 108. Because (in some embodiments) the client does not interact with the simulated environment except to observe the simulated environment, it may not be necessary to collect as many attributes 110 for the client as for the participants and the moderators. For example, the client data 108 may include manual trigger questions 112 similar to the manual trigger questions 102 of the moderator data 94, and access credentials 114 for allowing the client to access the simulated environment 66 and/or the VR server 10.

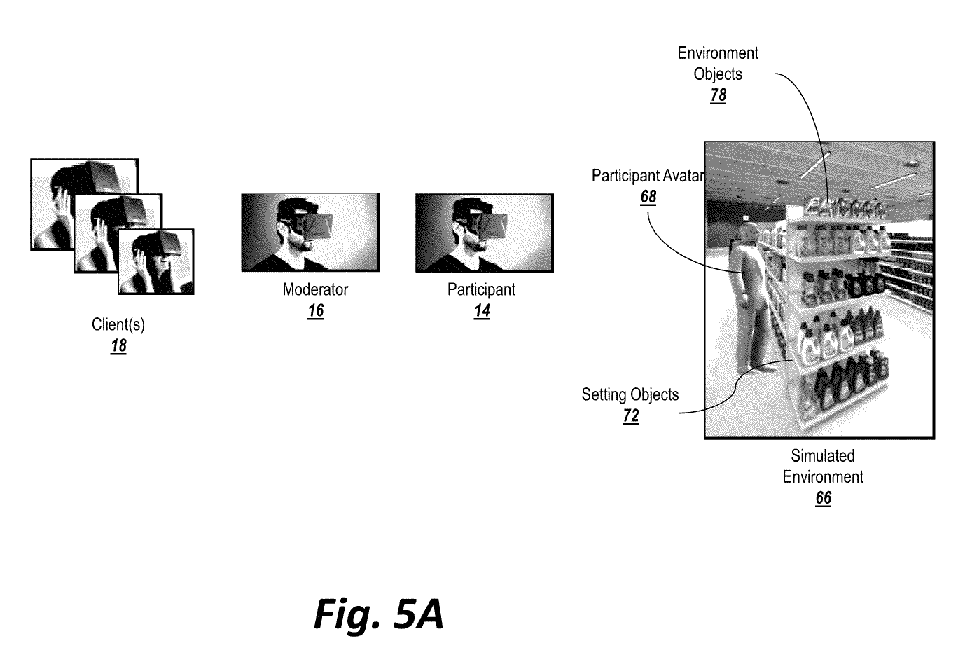

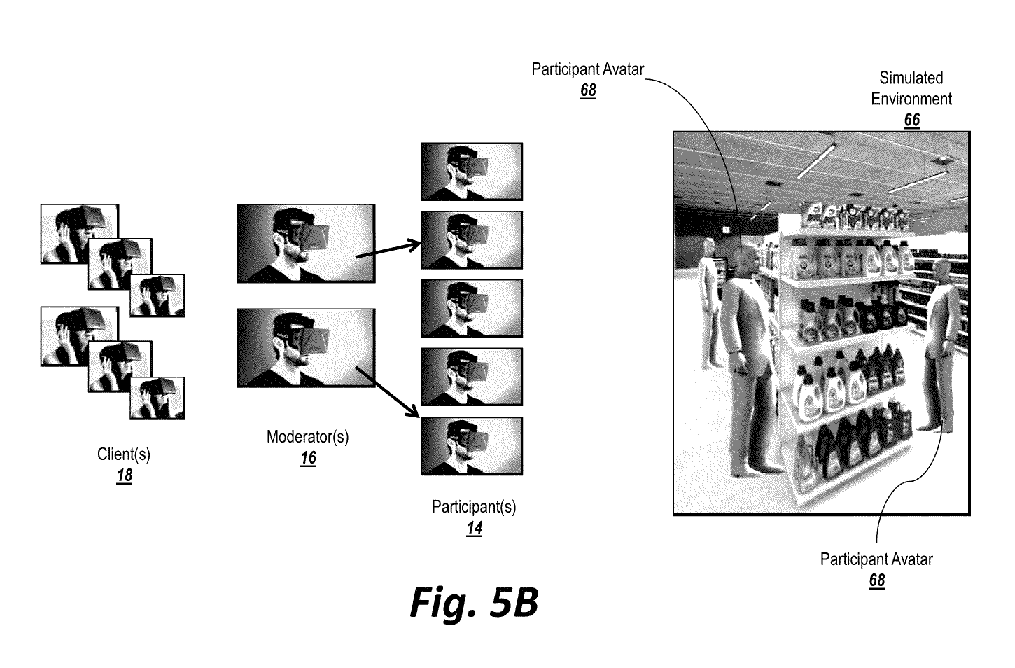

FIGS. 5A and 5B depict the participant(s) 14, the moderator(s) 16, and the client(s) 18 interacting with the simulated environment 66. FIG. 5A is an example in which a single participant 14 is present in the simulated environment while being directed by a single moderator 16. Multiple clients 18 may view the simulated environment, e.g. in a top-down perspective or from the perspective of the participant avatar 68.

FIG. 5B is an example in which multiple participants 14, moderators 16, and clients 18 interact with the simulated environment 66. As can be seen in FIG. 5B, each participant 14 may be provided with a participant avatar 68, and participants 66 may see other avatars in the simulated environment 66. Clients 18 and moderators 16 may choose which participants they wish to observe (e.g., by viewing the simulated environment 66 from the perspective of the selected participant, or by attaching an overhead “camera” to the selected participant and watching the participant from a third-person view). Alternatively or in addition, the clients 18 and the moderators 16 may observe the simulated environment 66 from a third person perspective, without following a particular participant. The clients 18 and the moderators 16 may be provided with interface options for switching their perspectives among the available options in real time.

The establishment and configuration of a simulated environment will be discussed next.

### Simulated Environment Initial Setup and Configuration

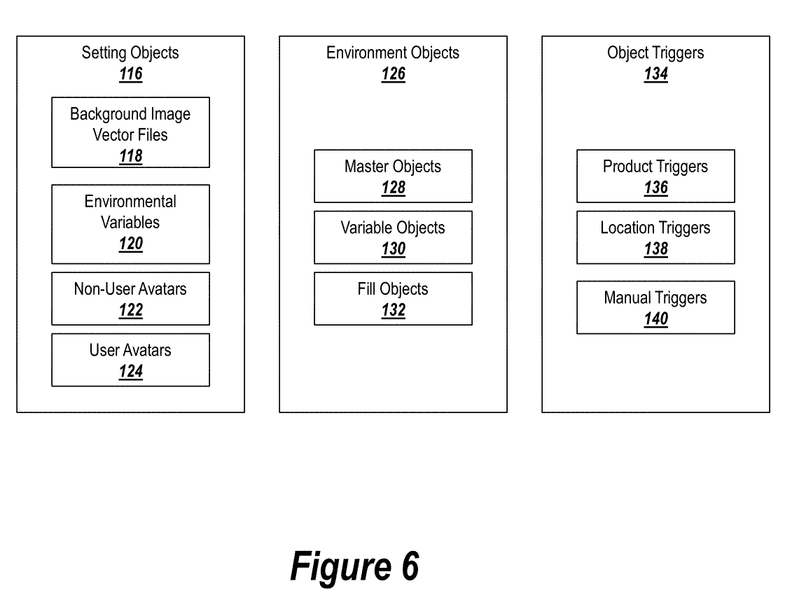

As noted above, and as depicted in FIG. 6, the simulated environment may be made up of setting objects 116, environment objects 126, and object triggers 134.

The setting objects 116 may represent objects that define the setting and/or context of the simulated environment. The setting objects may include background image vector files 118, which may be images that are rendered in the background of the simulated environment and may change depending on what type of simulated environment is being rendered. For example, the background image vector files 118 may include images representing the walls and shelves of a grocery store, a sales floor in a car dealership, a design showroom, etc.

The setting objects 16 may further include environmental variables 120. The environmental variables may further define how the simulated environment is represented, and may include elements such as music or other audio to be played in the simulated environment, details regarding lighting settings, etc.

The setting objects may also include non-user avatars 122 and user avatars 124. User avatars 124 may represent any participants, moderators, and/or clients (if client avatars are enabled) that are present in the simulated environment. Non-user avatars 122 may include simulated avatars that are not associated with any particular user, such as simulated virtual shoppers that behave according to pre-programmed and/or dynamic behaviors. Non-user avatars 122 may be entirely pre-programmed, and/or may be synthesized from other participant movements or legacy participant data.

The environment objects 126 include items that may be found in the simulated environment, such as cars, tires, products, etc. The environment objects 126 may include master objects 128. The master objects 128 include objects under study in the simulated environment, such as consumer products. The master objects 128 may include high resolution 3D vector maps of the target products.

The environment objects 126 may further include variable objects 130. The variable objects 130 may include variable visual information data points that may be mapped to the environment, such as changing price labels, varied product quantities, etc.

The environment objects 126 may further include fill objects 132. The fill objects 132 may include objects that are not an object of study, but which are present in the simulated environment to provide for a more realistic setting. For example, fill objects 132 may include product shelf displays, advertisements, etc.

The object triggers 134 may represent points in the simulated environment that, when interacted with, may cause an event (such as the posing of a survey question) to occur. The object triggers 134 may include product triggers 136. The product triggers 136 may be trigger locations associated with a particular product (e.g., a particular master object 128 or class of master objects 128), and may cause the display of a probing question based on an amount of gaze time or gaze points associated with the object.

The object triggers 134 may also include location triggers 138. The location triggers 138 may provide a visual display of a probing question based on the participant's avatar location in the simulated environment, or the amount of time that it takes the participant's avatar to reach a particular location.

The object triggers 134 may further include manual triggers 140, which may be triggers that can be activated by the moderator or a client. The triggers may cause a selected question from a question library to be posed, and may be triggered at any time.

FIG. 7 depicts examples of objects that may be used to make up the simulated environment in more detail. Specifically, FIG. 7 depicts a hardware agnostic canvas 22 having a number of environment objects 126, and translation mapping information 142 that may be used by the translation logic 28 to render the environment objects 126 in the simulated environment.

As can be seen in FIG. 7, the environment objects in the hardware agnostic canvas may include a number of details, such as an object ID for uniquely identifying the object, an object type, a location at which the object's data files (e.g., images for rendering the object, audio files played by the object, etc.) are stored, any trigger IDs associated with the object, and hardware-agnostic 3D coordinates for defining the object's location in the simulated environment.

The translation mapping information 142 may include hardware-specific information allowing the translation logic 28 to determine how the environment objects should be represented on particular hardware. For example, the translation logic may determine where (in an objective Cartesian coordinate system) the object should be displayed with respect to the participant's current perspective in the simulated environment, and may display the object at the location in the participant's field of view. The translation logic 28 may use information such as the resolution of the participant's hardware viewer, the hardware viewer's brightness and color settings, and information about whether the hardware viewer is capable of audio playback (among other hardware-specific information) in order to render the object appropriately for the hardware. For example, in the case of an environment object having vector image data, the image data may be stretched, rotated, etc. in order to be rendered properly on the participant's hardware at the specified location.

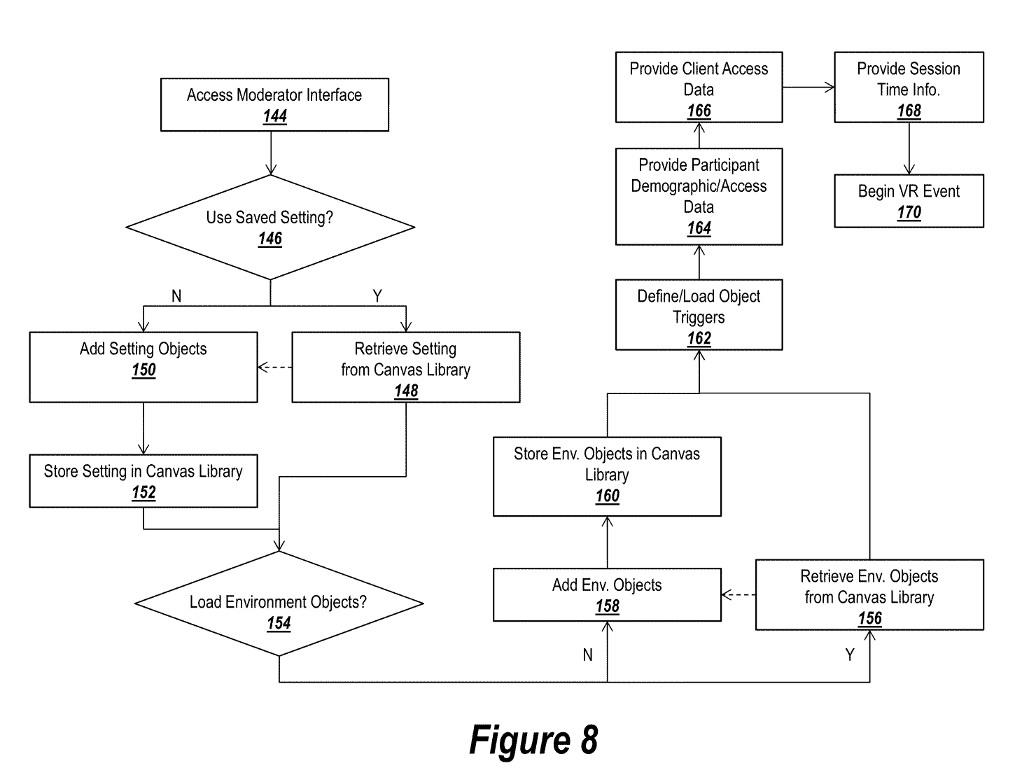

The setting objects 116, environment objects 126, and object triggers 134 may be used to build a simulated environment. FIG. 8 is a flowchart describing an exemplary process for building the simulated environment.

The simulated environment may, in some embodiments, be built by a moderator 16. Accordingly, at step 144 a user may log into the VR server 10 through the moderator interface 36. Among other options in the moderator's user interface, the VR server 10 may display an option for creating a simulated environment. Upon selection of this option, the VR server 10 may provide an interface for building a hardware agnostic canvas 22 for the simulated environment.

Previously built settings (e.g., generic settings such as grocery stores, car dealerships, or focus group rooms which may or may not be populated with environment objects) may be stored in a library for re-use. At step 146, the moderator 16 may be presented with an option for loading a pre-built setting from the library. If the moderator 16 chooses to load a pre-built setting at step 146, then processing may proceed to step 148 and the selected setting may be retrieved from the library. Processing may then (optionally) proceed to step 150, where additional setting objects may be added to the pre-built setting. If moderator does not choose to load a pre-built setting at step 146, then processing may proceed directly to step 150 and the setting may be built by placing setting objects in the blank setting.

After building the setting with setting objects at step 150, processing may proceed to step 152 and the moderator 16 may be presented with the option to save the built canvas in the canvas library for future use.

Once the moderator 16 is done placing setting objects, processing may proceed to step 154 and the moderator 16 may be provided with an interface for placing environment objects in the simulated environment. Alternatively or in addition, the moderator 16 may choose to rely on environment objects stored with the saved setting retrieved in step 148 and/or a previously stored environment object set that may be imported into the setting developed at steps 146-152.

If the moderator 16 chooses to rely on a previously-stored environment object set, processing may proceed to step 156 where the object set may be loaded (e.g., from the canvas library) and added to the simulated environment. Optionally, processing may then proceed to step 158, where additional environment objects may be added (e.g., from the canvas library), and from there to step 160 where the environment objects added to the simulated environment may optionally be saved in the canvas library for future use.

Processing may then proceed to step 162, where object triggers may be defined or loaded from the hardware agnostic input data 20. For example, an interface may be provided for allowing the moderator 16 to define survey questions, locations at which the questions are triggered, a required number of gaze points in order to trigger the questions, etc.

At step 164, the moderator 16 may define participant demographic information and access credentials. For example the moderator 16 may provide a list of users (e.g., a list of user IDs) who are permitted to participate in a research project involving the simulated environment established in steps 144-162. The participants may access the simulated environment through a participant interface 32 in the VR server 10. In some embodiments, the moderator 16 may define a list of demographics which a participant must have in order to access the simulated environment. In such a situation, the VR server 10 may assign participants to different simulated environments depending on their demographics.

At step 166 the moderator 16 may define client access data for allowing clients to access the simulated environment. For example, the moderator 16 may provide a list of client user IDs allowing the clients to log into client interfaces 38 in the VR server 10.

At step 168, the moderator 16 may provide session time information. The session time information may define at time at which a research project in the simulated environment is scheduled to take place. If a user attempts to log into the simulated environment at a time outside of the session time defined in step 168, an error message may be displayed informing the user when the research project is scheduled to begin. In some embodiments, users may be allowed to log into the research project a short predetermined amount of time prior to the session time defined in step 168. In this case, the user may be placed into a waiting room until the appointed time for the research project, and then may be placed in the simulated environment.

At the appointed time defined in step 168, processing may proceed to step 170, and the research project session may begin.

Once the research project begins, the VR server 10 may employ the translation logic 28 in order to render the simulated environment defined in steps 144-162 on user-specific hardware. FIG. 9 is a flowchart describing exemplary steps that may be performed by the translation logic 28.

Processing may begin at step 172, where a stored hardware-agnostic canvas associated with the current research project may be retrieved from the canvas library 22. In order to appropriately render the hardware agnostic canvas on user-specific hardware, translation mapping information describing how to render an environment on the user-specific hardware may be used. Such translation mapping information may be retrieved at step 174. The translation mapping information may be stored with, or separately from, the hardware agnostic canvas.

At step 176, the translation logic may retrieve or construct a blank hardware-specific scene or template. This may serve as the basis for a hardware-specific scene, to which setting and environment objects will be added. Alternatively, in some embodiments an entire scene may be generated in a hardware agnostic format, and then displayed on user-specific hardware by translating the finished scene.

At step 178, the translation object mat retrieve a setting object from the canvas. For example, if the setting objects are stored in a database, the translation logic may retrieve the next setting object from the database. The setting object may be associated with location information, such as coordinates in a Cartesian plane that are defined with respect to the simulated environment and/or the blank scene or template. This location information may be retrieved from the canvas library at step 180.

At step 182, appearance properties for the setting object may be retrieved. For example, a definition of the setting object may include a pointer or reference to image files (e.g., vector graphic images) that are used to draw the setting object in the simulated environment. The pointer or reference may be followed to extract the vector images from the associated image files.

At step 184, viewer-specific code or image data may be generated and added to the blank template generated at step 176. The code or image data may be generated, at least in part, based on the appearance properties determined at step 182, the object coordinates retrieved at step 180, and the translation mapping information retrieved at step 174. For example, the translation logic may consult the translation mapping information to determine display properties for the user-specific viewer hardware. The translation logic may use the location information to determine where, with respect to the direction the user may be looking (or how the user would observe the setting object from various angles), the object should be placed. The translation logic may place the object at the location, and may correct the object's image data based on the translation mapping information (e.g., by manipulating the object's image data, such as by stretching or rotating the object).

At step 186, the translation logic may determine whether there are additional setting objects to be added to the simulated environment. If so, processing may return to step 178 and additional setting objects may be added to the scene.

Once all the setting objects have been added to the scene, processing may proceed to step 188 and a similar process to that described at steps 178-184 may be carried out for environment objects. Step 188 generally corresponds to step 178, step 190 generally corresponds to step 180, step 192 generally corresponds to step 182, step 196 generally corresponds to step 184, and step 198 generally corresponds to step 186.

One additional step may be performed at step 194 with respect to the environment objects, which may involve identifying any triggers associated with the environment objects. The triggers may be associated with object or location data, and survey questions that may be displayed when the location or object is approached or viewed. Step 194 may involve generating code for the user-specific hardware that causes the survey questions to be posed when the user-specific hardware identifies that the triggering conditions are met. Alternatively or in addition, the trigger points may be triggered by the VR server 10 when the user-specific hardware reports that the user has approached or viewed the location associated with the trigger point.

In some embodiments, triggers may be associated with locations in the simulated environment rather than, or in addition to, associating the triggers with the environment objects.

Once the trigger points and environment objects have been added to the scene, processing may proceed to step 200 where the now-completed view of the simulated environment may be sent to the user-specific hardware, rendered by the user-specific hardware, and/or saved for future use.

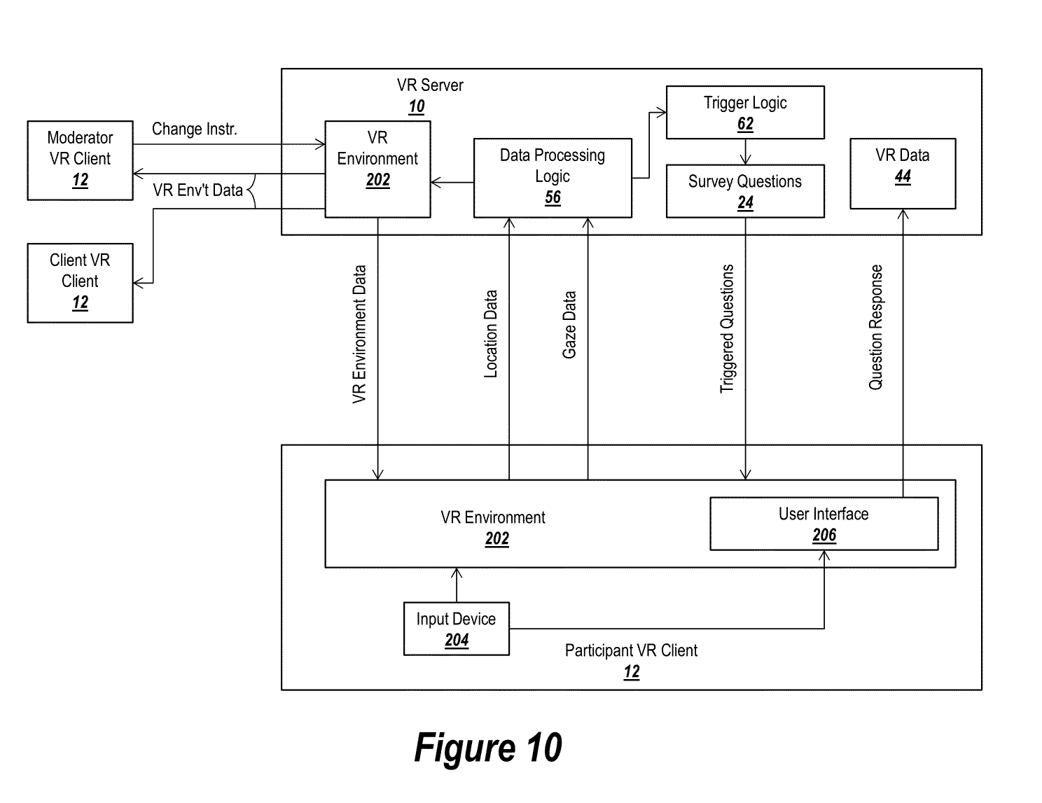

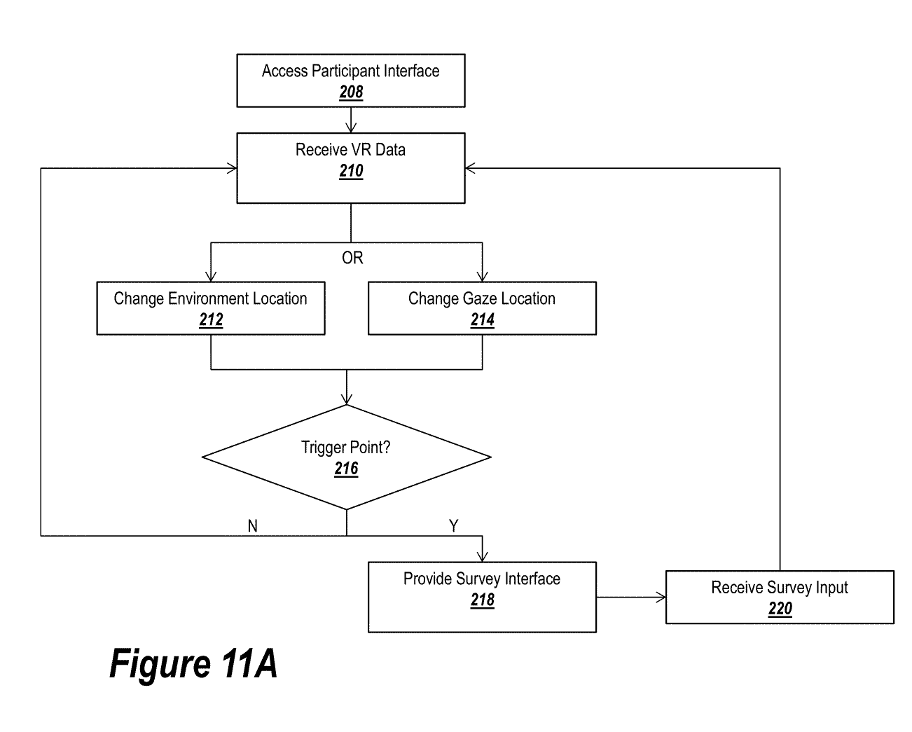

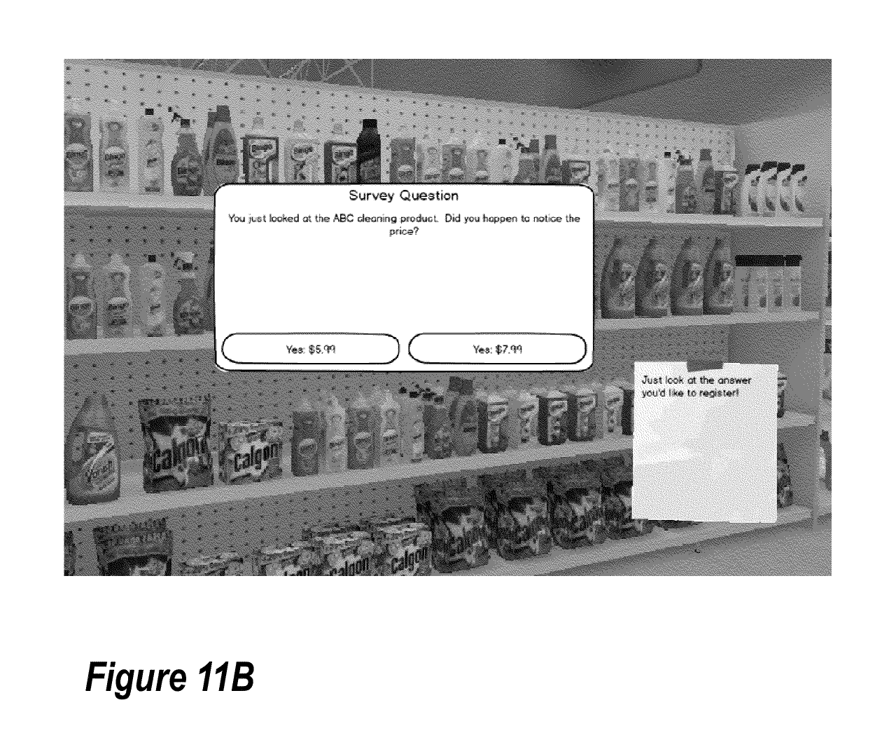

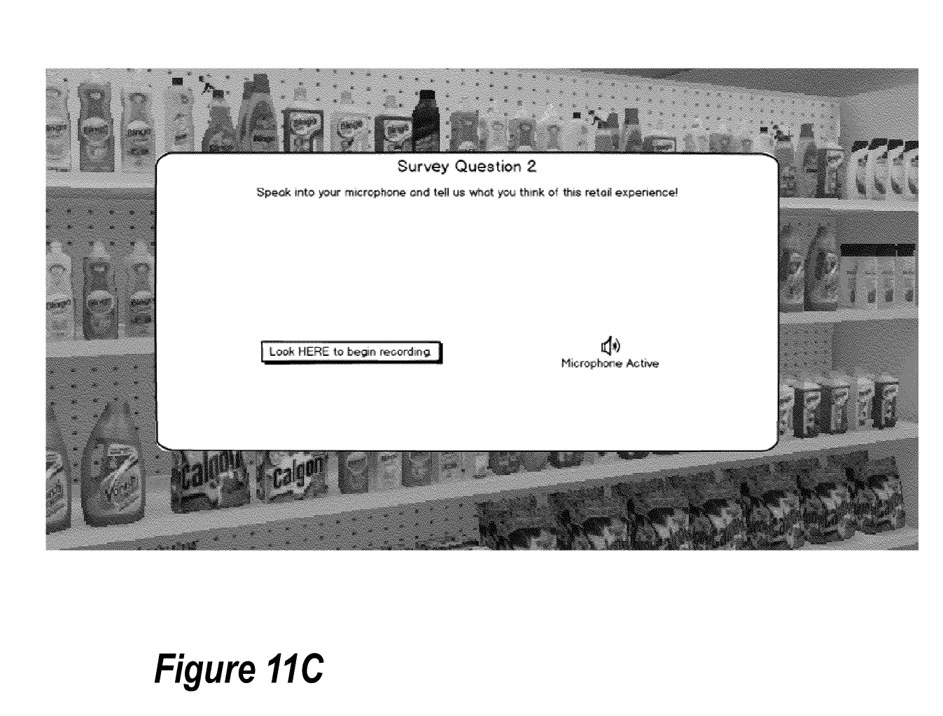

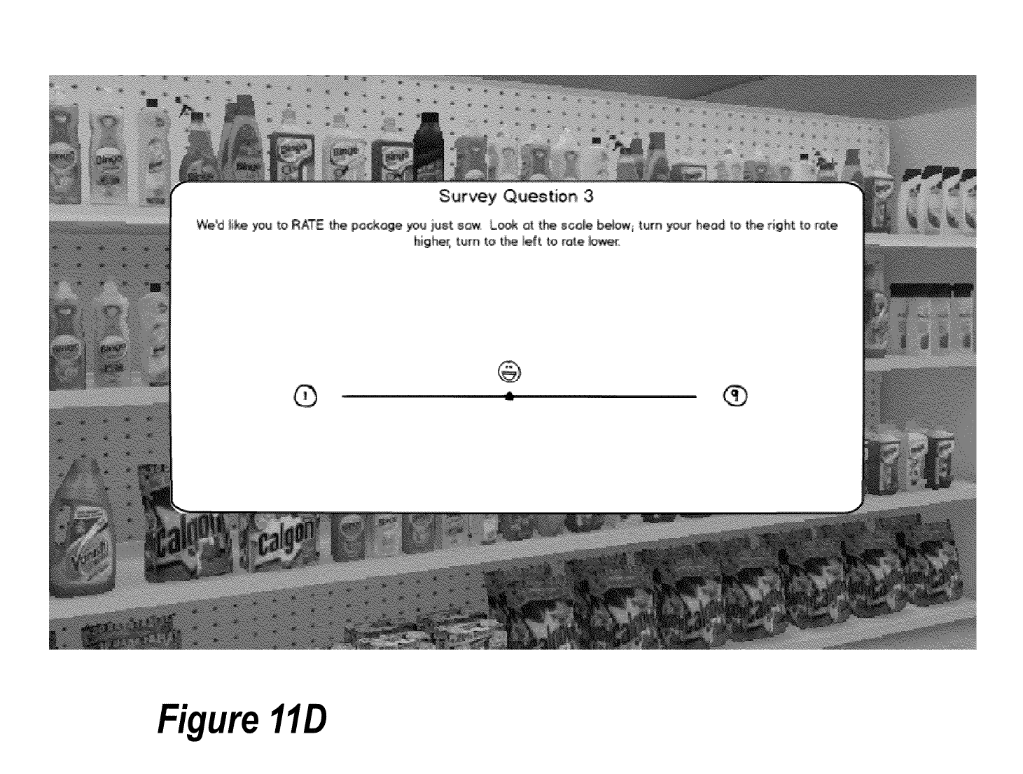

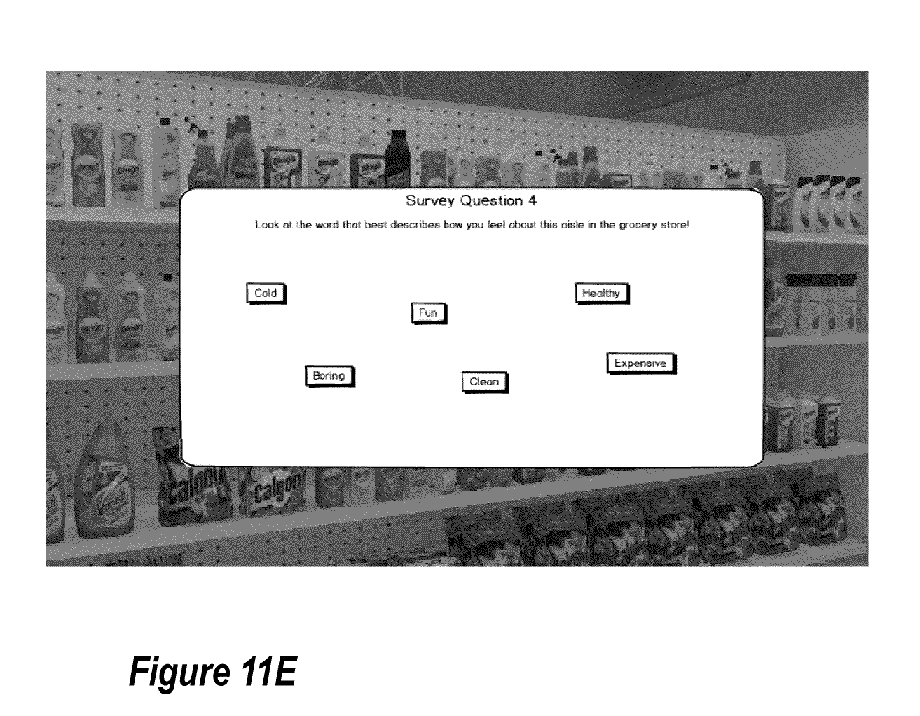

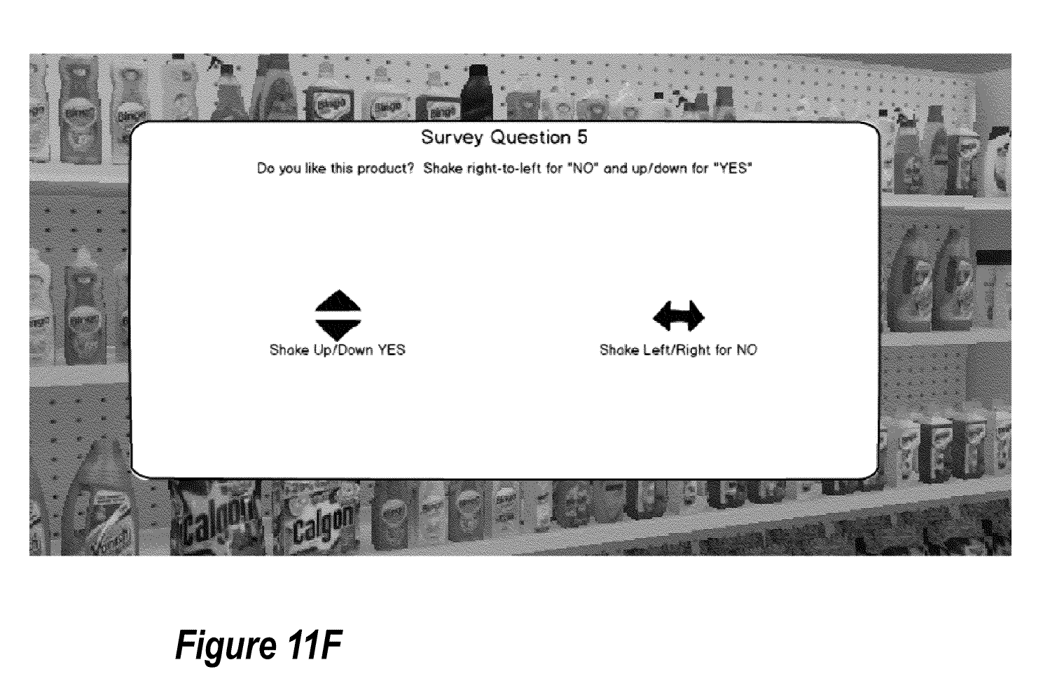

Thus, a simulated VR environment may be constructed and rendered for a variety of users. User interaction with the VR environment is next described with respect to FIGS. 10-11.

### Virtual Reality Environment Interaction

User-specific hardware may use the scene information generated in FIG. 9 to render the simulated environment and allow different users to interact with the simulated environment. FIG. 10 is a data flow diagram describing user interactions with the simulated environment.

The VR server 10 may host a copy of the simulated VR environment 202, or data associated with the VR environment 202 that allows each participant VR client 12 to generate their own copy of the simulated VR environment. In some embodiments, the VR server 10 may maintain information regarding the different users in the VR environment so that each user's avatar can be displayed to other users in the VR environment.

In some embodiments, the moderator interface may allow the moderator VR client to transmit a change instruction causing a change in the VR environment 202. For example, the change instruction may be an instruction to move a specified participant avatar to a specified location, to manually change the gaze direction of the participant, or to add new objects to the VR environment.

The VR server 10 may provide VR environment data to the VR clients 12 of participants, moderators, and clients, thereby allowing the VR clients 12 to render the VR environment 202. The VR clients 12 may be of homogeneous or heterogeneous types of hardware. Each type of user may interact with the VR server 10 through an appropriate type of interface 30, which may interpret instructions from the users differently according to the user's role.

If the user associated with a VR client 12 maintains an avatar in the VR environment 202, the VR client 12 may be provided with one or more input devices 204 allowing the user to interact with the VR environment 202. For example, the input devices 204 may include a joystick allowing the user to change the location of their avatar in the VR environment 202 and an accelerometer in a VR headset allowing the user's gaze location to be determined. Accordingly, each of the VR clients 12 associated with an avatar and/or viewer location (such as an invisible “camera” observing the VR environment 202) may transmit location data and gaze data to data processing logic 56 of the VR server 10.

The data processing logic may, in turn, provide the obtained information to trigger logic 62, which may determine if the user's avatar location or gaze location has triggered a survey question 24. If so, the triggered question may be provided to the VR environment 202 of the participant's VR client 12 and displayed on a user interface 206. In some embodiments, the survey question may be read aloud through a speaker in the participant VR client (and may be manually read by the moderator, or automatically played, e.g., through a previously-recorded sound file). The participant may use the input device(s) 204 to answer the survey questions, and the resulting question responses may be transmitted back to the VR serer 10 and stored in the VR data 44.

A flowchart of exemplary steps performed by the VR server 10 as the participant VR client 12 provides information about the participant's interaction with the VR environment 202 is depicted in FIG. 11A.

At step 208, the VR server 10 may access a participant interface through which the participant VR client 12 provides data and information. At step 210, the VR server 10 may receive VR data through the participant interface, which may include (for example) an updated participant avatar location and an updated participant gaze location.

The VR server 10 may compare the updated location and gaze data to previous location and gaze data to determine whether the user's position or gaze has changed (and thus needs to be updated). If so, processing may proceed to either or both of steps 212 and 214, where the participant's view of the VR environment and/or position in the environment may be updated. If necessary, new environment view data may be transmitted to the participant VR client 12, and the view of the environment may be updated on the VR client 12. If the participant's environment location is changed at step 212 and other users are also represented in the VR environment 202 by avatars, the updated participant location information may be transmitted to the other users' VR clients 12 so that the participant's updated avatar location can be rendered in the other users' VR clients 12.

At step 216, it may be determined whether updating the participant's position or gaze location has caused the participant to activate a trigger point. If not, processing may return to step 210 where next VR data from the participant may be received. If a trigger point is activated, processing may proceed to step 218 where the user may be presented with a survey interface for answering the survey questions. Upon providing an input responsive to the survey question, processing the input may be transmitted to the VR server 10 and received at step 220. The answers to the survey questions may be stored with the VR data 44.

Exemplary survey interfaces and exemplary means for supplying inputs to the survey interfaces are depicted in FIGS. 11B-11F. For example, 11B depicts a multiple choice survey question which queries the participant whether they noticed the price of the target product. The user may indicate a price by looking at one of the price options. Instructions may be provided on-screen in order to inform the user how to interact with the survey interface.

FIG. 11C depicts another survey interface that allows the participant to record audio providing their answer to the survey question. The audio recording functionality may be triggered by staring at a particular point on the survey interface, and recording may be stopped by looking away from the particular point, or at a different designated point. An indicator may be displayed informing the participant whether a microphone is currently recording their answer.

FIG. 11D provides an interface whereby a participant can indicate an answer requiring an indication of degree. In this case, the participant moves their head to the left or the right to move an icon along a slider bar. The participant's head movement may be measured, for example, by a sensor in the participant's VR headset.

FIG. 11E depicts an example of a multiple choice question. The participant may select one of the displayed choices by directing their gaze toward their selection.

FIG. 11F depicts an example of a question requiring a “yes” or “no” answer. In this case, the participant can select one choice or the other by nodding their head in an appropriate direction.

In addition to the answers to the survey questions, the VR data 44 may include individual and/or aggregated scores calculated based on participant's gaze locations. Exemplary score calculations are discussed below with respect to FIGS. 12-14.

### Score Calculations

As shown in FIG. 12, a participant may approach one or more environment objects representing different products on a display. The products may be placed in the simulated environment according to 3D coordinates associated with the associated environment objects. The VR server may extract 2D coordinates of the environment objects to identify a viewing plane representative of the areas of the participant's view in which the objects representative of a particular type of product is present. Different products may be associated with different sets of 2D coordinates.

Based on the 2D coordinates, a set of “gaze points” may be calculated for each type of product. The gaze points may represent an amount of attention (e.g., based on viewing time and the number of “second looks” given to the product). The participant's gaze may be represented as a single point (e.g., the center of the participants view), or may be represented as a series of gaze boxes. Exemplary gaze boxes are depicted in FIG. 12A.

The gaze boxes 222, 224, 226, 228 may be centered at the center of the participant's field of view in the simulated environment, and may expand concentrically from that point. Each gaze box may abut an adjacent gaze box such that the borders of each gaze box touch the borders of adjacent gaze boxes. In some embodiments, the gaze boxes may overlap such that there is a transition period when moving between adjacent gaze boxes. In such a circumstance, an object may be considered to remain in its existing gaze box until it moves out of the area of overlap and into a new gaze box.

The more central gaze boxes (e.g., 222, 224) may be assigned more gaze points than the outer gaze boxes (e.g., 226, 228) on the assumption that the user is paying the most attention to the center of their view. As gaze boxes move outward from the center of the field of view to the periphery, the gaze boxes may be given decreasing number of gaze points on the assumption that the user is paying less attention, but nonetheless some attention, to the more peripheral gaze boxes.

For example, a first gaze box 222 may be represented as the central area of the participant's field of view (e.g., extending from the center of the participant's field of view out to 5-15 degrees from the center of the participant's field of view, more preferably to 8-12 degrees, and more preferably to 10 degrees). Any environment objects or products present in the first gaze box may accumulate, for example, 30 points per millisecond.

A second gaze 224 box may extend in a secondary zone, such as from the border of the first gaze box out to 15-25 degrees from center, more preferably 18-22 degrees from center, and more preferably 20 degrees from center. Any environment objects or products present in the second gaze box may accumulate, for example, 10 points per millisecond.

A third gaze 226 box may extend in a tertiary zone, such as from the border of the second gaze box out to 35-45 degrees from center, more preferably 38-42 degrees from center, and more preferably 40 degrees from center. Any environment objects or products present in the third gaze box may accumulate, for example, 3 points per millisecond.

A fourth gaze box 228 may extend in a quaternary zone, such as from the border of the third gaze box to 180 degrees from center and may accumulate gaze points at a rate of 1 per millisecond, while a fifth gaze box 229 may include anything unseen and out of peripheral range, and may not accumulate any gaze points.

These values are intended to be exemplary, and one of ordinary skill in the art will recognize that other configurations or values may also be used.

In some embodiments, the size of the gaze boxes may be normalized based on the user's hardware (e.g., the resolution of the user's display device). The size of the gaze boxes may be defined such that users seeing different amounts of the environment have substantially the same amount of information (e.g., the same image when viewing substantially similar environment locations, albeit at different scales or resolutions) in their gaze boxes.

According to one embodiment, the size of the gaze boxes (and/or the timing values such as the first and second look intervals and away time, discussed below) may dynamically vary depending on the context in which the gaze boxes are employed and/or the actions of the user. For example, the size of the gaze boxes may be dependent on a user's speed, location, and/or distance from the objects in the user's field of view. In one embodiment, the first, second, and/or third gaze boxes may be made larger as the user increases in speed or is positioned further away from the objects in the user's field of view, under the assumption that the user is “taking in” a large number of products at once. On the other hand, when the user is close to an object or moving slowly (or is stationary), the size of the gaze boxes may be made smaller, under the assumption that the user is taking the time to focus on particular items.

The gaze score may be calculated in the manner above based on the first glance that the participant gives to a product. In some embodiments, the initial gaze score may be supplemented with additional accumulated gaze scores based on additional looks given to the product. In some embodiments, these second looks may be associated with a multiplier, on the assumption that a user directing their gaze away from the product and then returning to the product for a second look carries added significance.

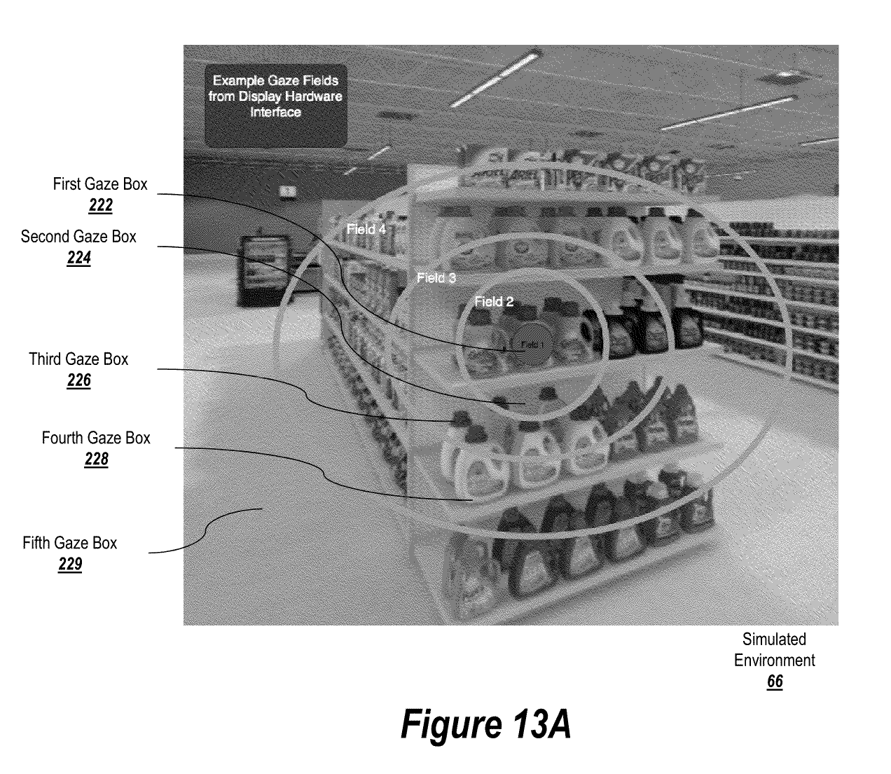

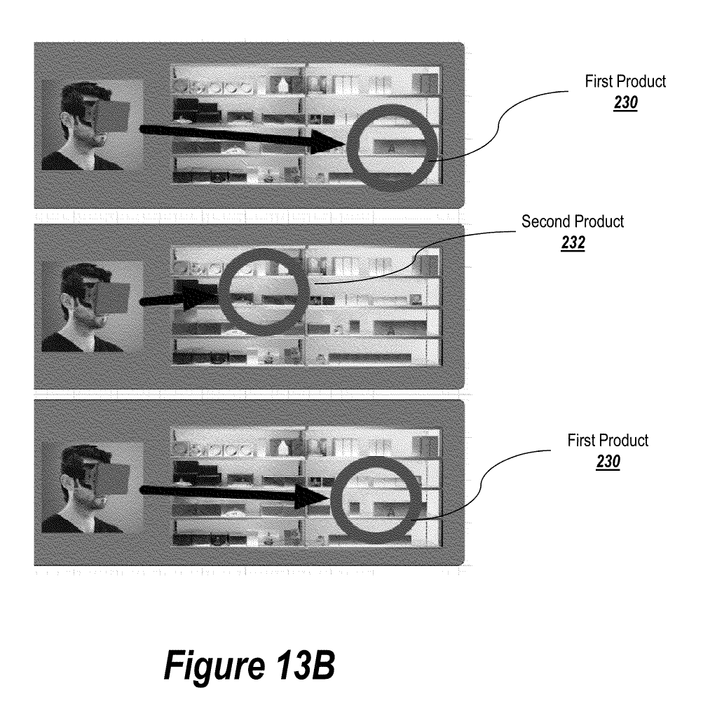

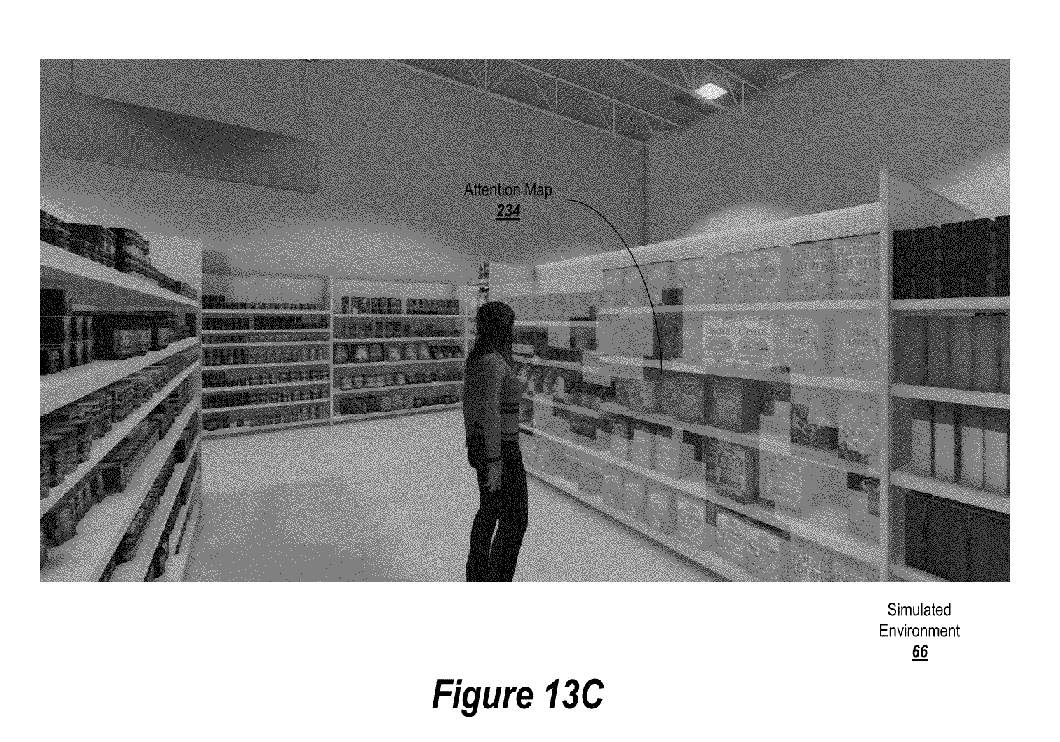

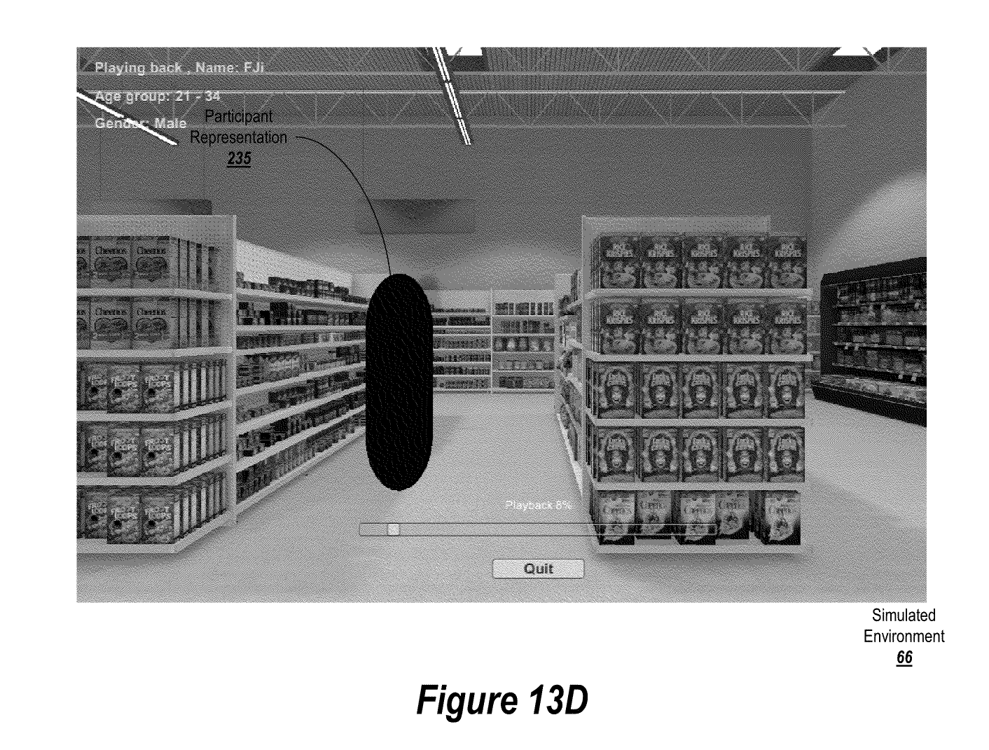

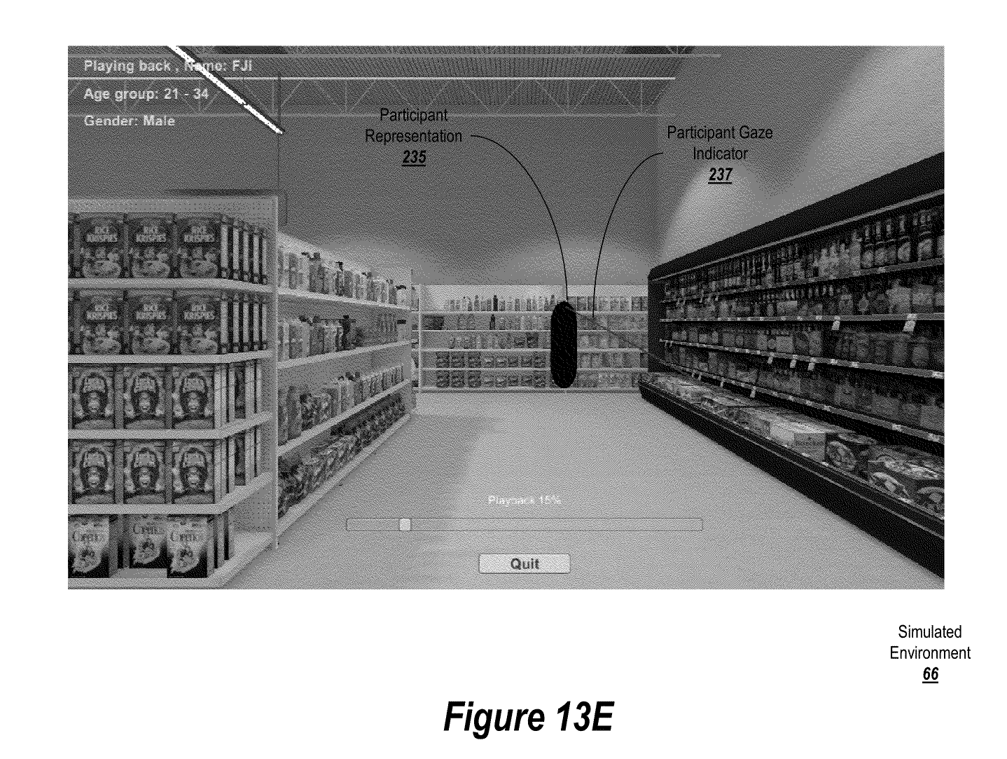

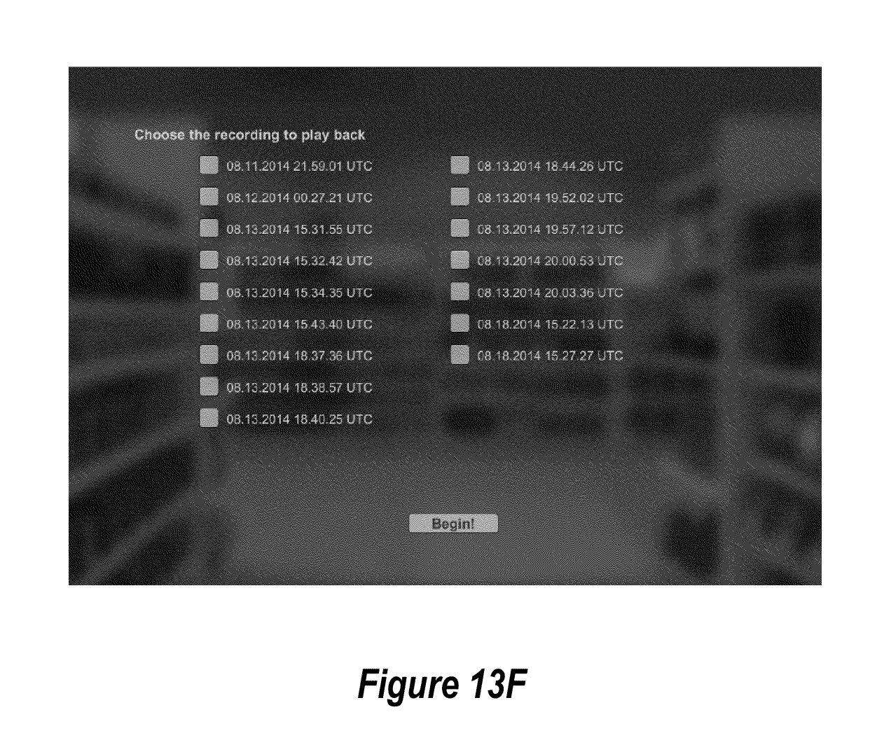

For example, FIG. 13B depicts a situation in which the user initially looks at a first product 230 (top panel). After the user has looked at the first product 230 for more than a predetermined threshold period of time (e.g., 1 second, referred to herein as the “initial gaze trigger”), a first timer may start to measure the amount of time that the product is given a “first look.” The use of the predetermined threshold period of time may help to ensure that the user is actually looking at the object, instead of scanning panning around the simulated environment.

According to some embodiments, the timer for the initial gaze trigger may start when the first product 230 initially enters the first gaze box 222. The first timer may run until the first product 230 leaves the first gaze box 222, or leaves a more peripheral gaze box (such as the second gaze box 224, the third gaze box 226, or the fourth gaze box 228).

According to other embodiments, the timer for the initial trigger may start when the first product 230 first moves into any gaze box nearer than the fifth gaze box 229 (e.g., the first gaze box 222, second gaze box 224, third gaze box 226, or fourth gaze box 228). The first timer may stop when the first product 230 either moves into a more peripheral gaze box, or into the fifth gaze box.

According to yet another embodiment, the timer for the initial trigger may start when the first product 230 first enters an intermediate gaze box, such as the second gaze box 224, and the timer may run until first product 230 either moves into a more peripheral gaze box, or into the fifth gaze box.

Still further, in some embodiments the first product 230 may begin accumulating first look “points” as soon as the first product 230 moves into the fourth gaze box 228, and may gain more or fewer points as the first product 230 enters different gaze boxes (e.g., more points for more central gaze boxes, and fewer points for more peripheral gaze boxes). The first product 230 may stop accumulating first look points when the first product exits to the fifth gaze box 229.

One of ordinary skill in the art will recognize that the particular gaze boxes used to trigger the start and end of the timers or the accumulation of first look points may vary depending on the application.

After viewing the first product 230, the user may then redirect their gaze to a second product 232 (middle panel). Upon removing their gaze from the first product 230, the first timer may stop. A new timer may be started for the user's first look at the second product. In addition, an “away timer” may be started in order to measure the amount of time that the user's gaze is directed away from the first product 230. The away timer may be used to ensure that the user's gaze is directed away from the first product 230 for more than a predetermined threshold period of time (referred to herein as the second look minimum interval). This allows the system to account for situations in which the user moved their gaze away from the first product 230 in a manner that does not indicate that the user intended to look away from the first product 230 (e.g., if the viewer moved as a result of the user sneezing or shaking their head).

It is noted that the user need not necessarily redirect their gaze to a second product 232 in order to start the away timer. It may be sufficient that the user simply looks away from the first product 230.

Subsequently, the user redirects their gaze again to the first product 230 (bottom panel). If the away timer indicates that the user did not redirect their gaze away from the first product 230 for more than the predetermined period of time, then this viewing of the first product 230 may still be treated as the “first look,” (e.g., the first timer may continue to accumulate time). If the away timer indicates that the user did redirect their gaze away from the first product 230 for more than the predetermined period of time, then this viewing of the first product 230 may be treated as a “second look.”

After again viewing the first product 230 for more than the predetermined threshold period of time (e.g., again using the initial gaze trigger), a second timer may be started to measure the amount of time that the user devotes to the second look. The second timer may continue until the user again redirects their gaze away from the first product 230.

The second timer may start in response to the first product 230 moving into a gaze box in a manner similar to that for the initial gaze trigger, discussed above.

Using the first timer and the second timer, a number of “points” may be assigned to the first product 230. For example, the first product 230 may accumulate points in a linear fashion such that first product 230 receives a constant number of points for each second that the first product 230 is in view. Alternatively, the first product 230 may accumulate points in a non-linear fashion. For example, the first product 230 may accumulate points in an exponential fashion, such that the first product 230 is awarded increasingly more points the longer the first product 230 remains in view. This may allow different numbers of points to be assigned depending on the intensity of the user's view (e.g., awarding more points for a “stare” than a “glance”).

Based on the raw gaze data, a formula may be used to calculate an overall gaze score. For example, one exemplary formula may be given by Equation 1:

F=A+M*B (1)

Where F is the overall gaze score, A is the initial set of gaze points (e.g., the first look points described above), B is the number of second look points (calculated in the same manner as described above but only after the user has initially viewed a product and then moved their gaze away from the product), and M is a “second look multiplier.” In one example, M is given by Equation 2:

M=1+(T*0.1) (2)

where T represents an amount of time spent away from the product as measured by the away timer (e.g., the time in seconds since the object entered gaze box 2, then completely left gaze box 4). By using the away timer in the second look multiplier, more value may be assigned to a product if the user returned to the product after a long period of time away, perhaps indicating that the user remembered the product for a long period of time and made the decision to come back to the product.

Alternatively, the multiplier M may be a predefined multiplier (e.g., +20%).

One of ordinary skill in the art will recognize that this formula is exemplary only, and may be modified based on the application. Further, the same logic may be extended to give different (e.g., increasing) scores based on a “third look,” “fourth look,” etc.

Some embodiments may further make use of a “second look maximum interval,” which represents an amount of time that the user is permitted to direct their gaze away from the first product 230 (as measured by the away timer) before the first product 230 “resets” and is no longer eligible for second look points that are multiplied in value. This may prevent second look points from accumulating when the user is freely roaming in the simulated environment and returns to a product much later than the initial viewing of the product. Such an extended absence may indicate that the user is not returning to the product because the user remembers the product, but rather because the viewer has simply cycled back to a previously-visited area of the store.

Exemplary ranges of values are given below for the initial gaze trigger, second look minimum interval, second look multiplier, and second look maximum interval.

The initial gaze trigger may be, in some embodiments and depending on the application, 0-5 seconds, more preferably 0.5-2 seconds, and still more preferably 1 second.

The second look minimum interval may be, in some embodiments and depending on the application, 0-5 seconds, more preferably 0.5-2 seconds, and still more preferably 1 second.

The second look multiplier may be, in some embodiments and depending on the application, 0.05-0.5, more preferably 0.1-0.3, and still more preferably 0.2.

The second look maximum interval may be, in some embodiments and depending on the application, 30-90 seconds, more preferably 45-75 seconds, and still more preferably 60 seconds.

An example of the calculation of gaze points in now described. Assume that a user directs their field of view such that a target object enters the first gaze box 222 for more than one second. The target object remains in the first gaze box 222 for a period of time such that the target object earns 1000 first look points, and then the user redirects their view (e.g., by moving a head mounted VR display) completely away from the object (e.g., to the fifth gaze box 229) for five seconds. The user then returns to the target object and views it again for a period of time corresponding to 2000 second look points. Applying Equations 1 and 2 above, the overall score for the target object would be given as:

### A=1000

### M=0.2

### B=2000

### T=5

### 1000+(1+(5*0.2)*2000)=F

### 5000=F

In some embodiments, the gaze scores may be aggregated across multiple participants and/or stored separately for each participant. The gaze scores (individual or aggregate) may be represented visually in the simulated environment 66 in the form of a gaze map or analytical trail. This may allow the moderator or client to quickly and easily determine which products have received the most attention. The gaze map 234 may be displayed as an overlay on various products in the simulated environment 66 when the moderator or client is present in the simulated environment. The moderator or client may be given the ability to toggle the gaze map 234 on or off.

An exemplary gaze map 234 is depicted in FIG. 13C. Areas at which gaze points have been accumulated to a greater degree may be distinguished, for example using different colors or patterns, among other means of visually distinguishing different areas of attention.

At any point, a moderator or client may “replay” a selected participant's actions in order to review the participant's experience. FIGS. 13D and 13E depict an exemplary playback in which a representation 235 of the participant (e.g., the participant's avatar or, in this case, a simplified shape) moves through the simulated environment in the same manner as the participant did during the participant's session. They playback may be facilitated using the VR data 44 of the VR server 10, for example. Among other features, the moderator or client may instruct the system to display a gaze line 237, as shown in FIG. 13, to more clearly show where the participant has directed their gaze. The moderator or client may select from among multiple available recordings of different participants (or the same participant at different times) using a menu like the one depicted in FIG. 13F.

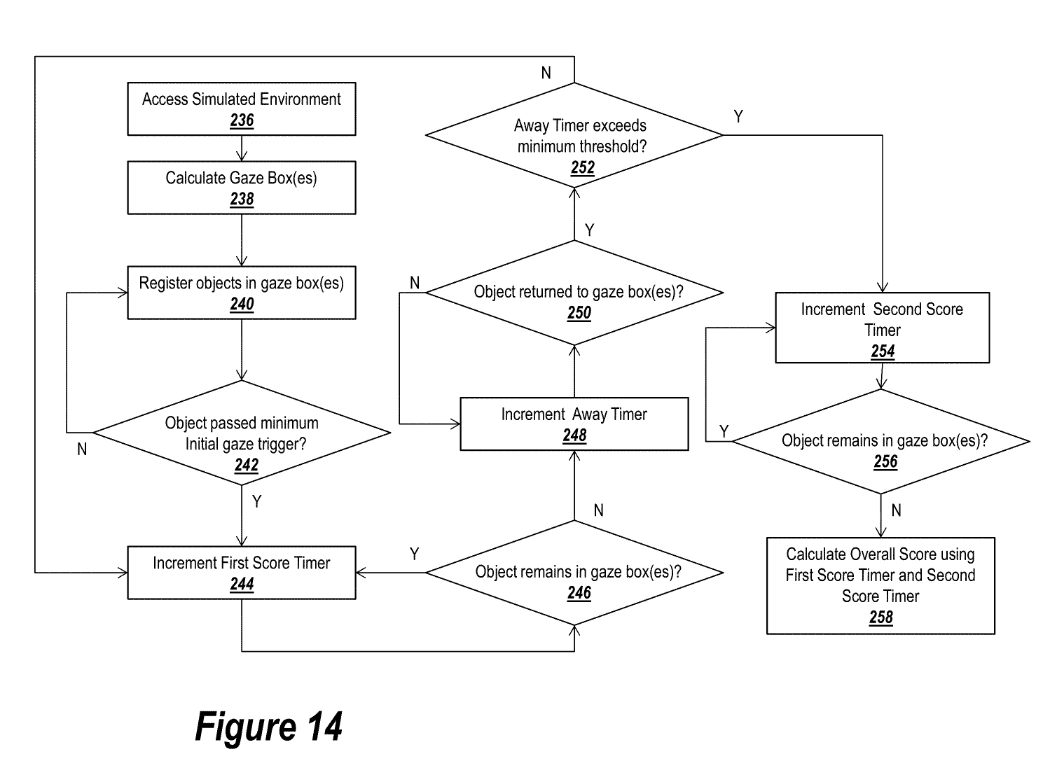

Furthermore, the above-described gaze scores may be captured and stored for future review. FIG. 14 is a flowchart depicting exemplary steps for calculating overall gaze scores. At step 236, a participant may access the simulated environment and interact with the simulated environment.

At step 238, a device (e.g., the user's display device, the central server, or any other suitable device) may calculate one or more gaze boxes in the user's field of vision. The device may, for example, identify a point as representing the center of the user's field of vision, and calculate one or a series of gaze boxes extending concentrically from the center of the user's field of vision. Exemplary gaze box sizes have been discussed above with reference to FIG. 13A.

At step 240, the device may register that one or more objects are present in one or more of the gaze boxes. The device may start an initial timer when the object enters the gaze boxes. The particular gaze box which the object(s) must enter in order to trigger the initial timer may depend on the application, and exemplary configurations have been discussed above with reference to FIG. 13B.

At step 242, the device may determine whether the object has passed the initial gaze trigger based on the readings in the initial timer. If not, processing may return to step 240 until such time as the object either is reevaluated or the object moves out of the user's gaze box(es).

If the determination at step 242 is “yes,” processing may proceed to step 244 where the first score timer may be started/incremented. At step 246, it may be determined whether the object remains in the user's gaze box(es) and, if so, processing may return to step 244 and the first score timer may be further incremented.

If the determination at step 246 is “no,” (i.e., the object has moved out of the user's gaze box(es)), then processing may proceed to step 248 and the away timer may be initiated/incremented.

Processing may then proceed to step 250 where it may be determined whether the object has returned to the user's gaze box(es). If not (i.e., the object remains out of the user's field of view), then processing may return to step 248 and the away timer may be further incremented. If so, (i.e., the object has returned to the user's field of view), then processing may proceed to step 252.

At step 252, it may be determined whether the away time exceeded the second look minimum interval. If not, then the time spent away from the object may be considered only transitory, and the system may treat the user as having never looked away from the object (i.e., the continued viewing of the object is still considered a “first look”). Accordingly, processing may return to step 244 and the first score timer may continue to accumulate time.

If the determination at step 252 is “yes,” then processing may proceed to step 254 where a second score timer may be initiated/incremented. At step 256, it may be determined whether the object remains in the user's gaze box(es) and, if so, processing may return to step 256 and the second score timer may be further incremented.

If the determination at step 252 is “no,” (i.e., the object has moved out of the user's gaze box(es)), then processing may proceed to step 258, where the second score timer may be stopped. At step 258, an overall score may be calculated using the first score timer and the second score timer (e.g., in accordance with Equations 1 and 2, above).

Using the exemplary procedure of FIG. 14, an overall score may be calculated for each product. The overall score may be represented, for example, on as an analytical trail or attention map as shown in FIG. 13C.

An exemplary computing system or electronic device for implementing the above-described technologies is next described.

### Computer-Implemented Embodiments

Some or all of the exemplary embodiments described herein may be embodied as a method performed in an electronic device having a processor that carries out the steps of the method. Furthermore, some or all of the exemplary embodiments described herein may be embodied as a system including a memory for storing instructions and a processor that is configured to execute the instructions in order to carry out the functionality described herein.

Still further, one or more of the acts described herein may be encoded as computer-executable instructions executable by processing logic. The computer-executable instructions may be stored on one or more non-transitory computer readable media. One or more of the above acts described herein may be performed in a suitably-programmed electronic device.

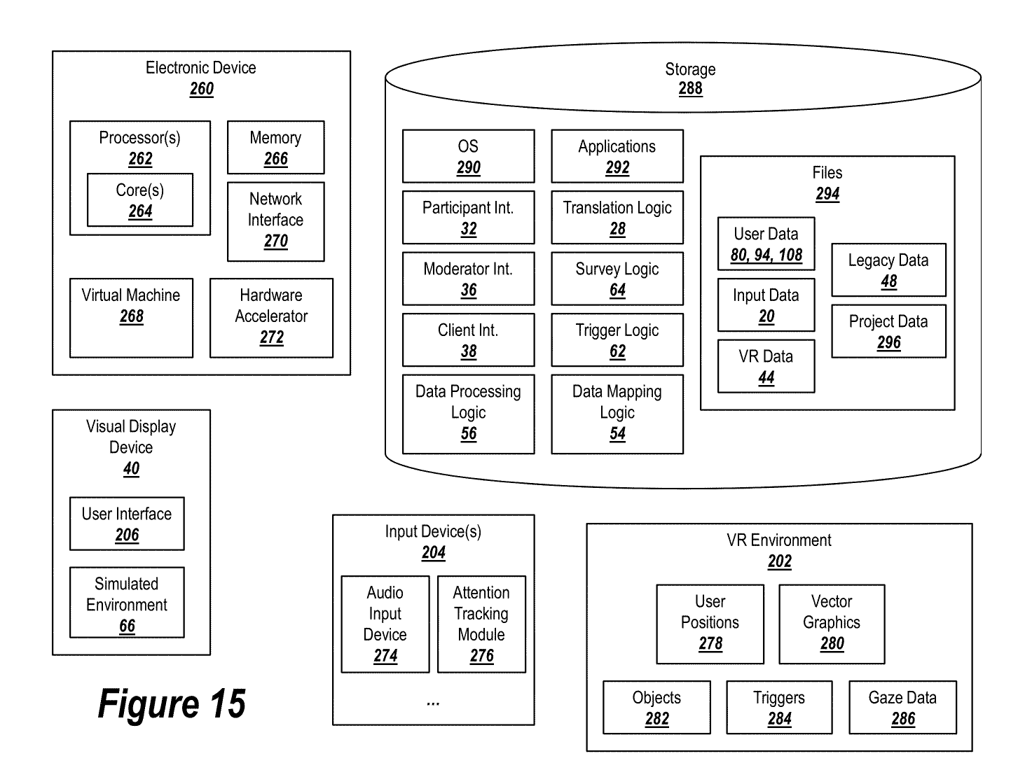

An exemplary electronic device 260 is depicted in FIG. 15. The electronic device 260 may take many forms, including but not limited to a computer, workstation, server, network computer, quantum computer, optical computer, Internet appliance, mobile device, a pager, a tablet computer, a smart sensor, application specific processing device, etc.

The electronic device 260 described herein is illustrative and may take other forms. For example, an alternative implementation of the electronic device may have fewer components, more components, or components that are in a configuration that differs from the configuration described below. The components described below may be implemented using hardware based logic, software based logic and/or logic that is a combination of hardware and software based logic (e.g., hybrid logic); therefore, components described herein are not limited to a specific type of logic.

The electronic device 260 may include a processor 262. The processor 262 may include hardware based logic or a combination of hardware based logic and software to execute instructions on behalf of the electronic device 260. The processor 262 may include one or more cores 264 that execute instructions on behalf of the processor 262. The processor 262 may include logic that may interpret, execute, and/or otherwise process information contained in, for example, a memory 266. The information may include computer-executable instructions and/or data that may implement one or more embodiments of the invention. The processor 262 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor 262 may include a single core or multiple cores. Moreover, the processor may include a system-on-chip (SoC) or system-in-package (SiP).

The electronic device 260 may include a memory 266, which may be embodied as one or more tangible non-transitory computer-readable storage media for storing one or more computer-executable instructions or software that may implement one or more embodiments of the invention. The memory 266 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

The electronic device 260 may include a virtual machine (VM) 268 for executing the instructions loaded in the memory 266. A virtual machine 268 may be provided to handle a process running on multiple processors 262 so that the process may appear to be using only one computing resource rather than multiple computing resources. Virtualization may be employed in the electronic device 260 so that infrastructure and resources in the electronic device 260 may be shared dynamically. Multiple VMs 268 may be resident on a single electronic device 260.

A hardware accelerator 272 may be implemented in an ASIC, FPGA, or some other device. The hardware accelerator 272 may be used to reduce the general processing time of the electronic device 260.

The electronic device 260 may include a network interface 270 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 270 may include a built-in network adapter, network interface card, personal computer memory card international association (PCMCIA) network card, card bus network adapter, wireless network adapter, universal serial bus (USB) network adapter, modem or any other device suitable for interfacing the electronic device to any type of network capable of communication and performing the operations described herein.

The electronic device 260 may include one or more input devices 204, such as a keyboard, a multi-point touch interface, a pointing device (e.g., a mouse), a joystick or gaming device, a gyroscope, an accelerometer, a haptic device, a tactile device, a neural device, a microphone, or a camera that may be used to receive input from, for example, a user. Note that electronic device 260 may include other suitable I/O peripherals.

Among other possibilities, the input devices 204 may include an audio input device 274, such as a microphone or array of microphones, and an attention tracking module 276. The attention tracking module 276 may be, for example, a device for directly tracking the user's attention (e.g., eye-tracking hardware that monitors the location to which the user's eyes are directed), a device for indirectly tracking the user's attention (e.g., a virtual reality headset that determines the location in which the user is looking based on accelerometer or compass data indicating the direction in which the user is pointing their head), and/or logic for imputing the user's attention based on the user's behavior (e.g., logic for interpreting a user's mouse clicks on a canvas or analyzing a survey response).

The input devices 204 may allow a user to provide input that is registered on a visual display device 40. The visual display device may be, for example, a virtual reality headset, a mobile device screen, or a PC or laptop screen. A simulated environment 66 may be displayed on the visual display device 40. Furthermore, a graphical user interface (GUI) 206 may be shown on the display device 40. The GUI 206 may display, for example, forms on which information, such as user information or survey questions, may be presented.

The input devices 204 and visual display device 40 may be used to interact with a virtual reality environment 202 hosted or supported by the electronic device 224. The virtual reality environment 202 may track user positions 278 (e.g., a location of user avatars within the virtual reality environment 202), provide vector graphics 280 for rendering objects and avatars in the environment, object data 282, trigger data 284, and gaze data 286 representing locations to which participants have directed their gaze.

A storage device 288 may also be associated with the electronic device 260. The storage device 288 may be accessible to the processor 262 via an I/O bus. Information stored in the storage 288 may be executed, interpreted, manipulated, and/or otherwise processed by the processor. The storage device 288 may include, for example, a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 288 may further store files 294, applications 292, and the electronic device 260 can be running an operating system (OS) 290. Examples of OSes 290 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device 260 and performing the operations described herein. The operating system 290 may be running in native mode or emulated mode.

The files 294 may include files storing the user data 80, 94, 108 (see FIG. 4), input data 20 (such as hardware-agnostic canvases and survey questions), VR data 44 including translation mapping information 142 for different types of proprietary VR devices (see FIG. 7), legacy data 48, and project data 296 describing the current behavioral research project.

The storage device may further store the logic for implementing above-described participant interface 32, moderator interface 36, client interface 38, data processing logic 56, translation logic 28, survey logic 64, trigger logic 62, and data mapping logic 54, along with any other logic suitable for carrying out the procedures described in the present application.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

1. A system comprising:
a non-transitory computer readable storage medium storing a representation of a simulated environment comprising a plurality of objects; and
a processor programmed to:
register a gaze location within the simulated environment,
recognize that a target object from the plurality of objects is within the gaze location,
calculate a first score for the target object in response to the target object being within the gaze location,
recognize that the gaze location moves away from the target object and then returns to the target object,
calculate a second score for the target object in response to the target object returning to the gaze location, and
calculate an overall score for the target objet based on the first score and the second score.

2. The system of claim 1, wherein the overall score is calculated according to the formula:
F=A+M*B,
where F is the overall score, A is the first score, B is the second score, and M is a second look multiplier.

3. The system of claim 2, wherein M is a value selected from a range of 0.05-0.5.

4. The system of claim 2, wherein M is a value selected form a range of 0.1-0.3.

5. The system of claim 2, wherein M is calculated according to the formula:
M=1+(T*0.1),
where T represents an amount of time spent away from the target object when the gaze location moves away from the target object and then returns to the target object.

6. The system of claim 1, wherein recognizing that a target object from the plurality of objects is within the gaze location accounts for an initial gaze trigger which requires that the target object be within the gaze location for a minimum amount of time before recognizing the target object.

7. The system of claim 6, wherein the initial gaze trigger is a value selected from a range of 0-5 seconds.

8. The system of claim 6, wherein the initial gaze trigger is a value selected from a range of 0.5-2 seconds.

9. The system of claim 1, wherein recognizing that the gaze location returns to the target object accounts for a second look minimum interval which requires that the target object be within the gaze location for a minimum amount of time before recognizing that the gaze location returns to the target object.

10. The system of claim 7, wherein the second look minimum interval is a value selected from a range of 0-5 seconds.

11. The system of claim 7, wherein the initial gaze trigger is a value selected from a range of 0.5-2 seconds.

12. The system of claim 1, wherein recognizing that the gaze location returns to the target object accounts for a second look maximum interval which requires that the target object be returned to the gaze location within a maximum amount of time before recognizing that the gaze location returns to the target object.

13. The system of claim 12, wherein the second look maximum interval is a value selected from a range of 30-90 seconds.

14. The system of claim 12, wherein the second look maximum interval is a value selected form a range of 45-75 seconds.

15. The system of claim 1, wherein either or both of the first score and the second score are calculated in a non-linear manner with regards to an amount of time that the target object is within the gaze location.

16. The system of claim 1, wherein calculating the overall score comprises weighting the second score more than the first score.

17. The system of claim 1, further comprising a display device displaying the simulated environment, wherein registering the gaze location comprises calculating a gaze box centered on a location in which the display device is pointed in the simulated environment.

18. The system of claim 1, further comprising:
displaying the simulated environment on a display device, and
displaying an analytical trail on the displayed simulated environment, the analytical trail visually distinguishing the plurality of objects in the simulated environment based on the respectively calculated overall scores for the plurality of objects.

19. The system of claim 18, wherein the analytical trail is calculated based on aggregated overall scores from a plurality of users.

20. A non-transitory computer-readable medium storing instructions that, when executed by one or more processors, cause the processors to:
access a representation of a simulated environment comprising a plurality of objects;
register a gaze location within the simulated environment,
construct a gaze box around the gaze location, wherein the gaze box is centered on a location in which the display device is pointed in the simulated environment,
recognize that a target object from the plurality of objects is within the gaze box, and
calculate a score for the target object in response to the target object being within the gaze box.

21. The medium of claim 20, wherein a size of the gaze box varies dynamically as a user interacts with the simulated environment.

22. The medium of claim 21, wherein the gaze box is made larger as user's speed increases and smaller as user's speed decreases.

23. The medium of claim 21, wherein the gaze box is made larger as a distance from the target object increases and smaller as a distance from the target object decreases.

24. The medium of claim 20, wherein a size of the gaze box is normalized based on information about hardware on which the simulated environment is displayed.

25. The medium of claim 20, further comprising calculating a plurality of gaze boxes extending concentrically from the location in which the display device is pointed in the simulated environment.

26. The medium of claim 25, wherein the plurality of gaze boxes comprise a first gaze box that extends from the location in which the display device is pointed in the simulated environment out to a value in a range of 5-15 degrees from the location in which the display device is pointed in the simulated environment.

27. The medium of claim 25, wherein the plurality of gaze boxes comprise a first gaze box that extends from the location in which the display device is pointed in the simulated environment out to a value in a range of 8-12 degrees from the location in which the display device is pointed in the simulated environment.

28. The medium of claim 25, wherein a number of the gaze boxes is five.

29. The medium of claim 25, wherein calculating the score comprises assigning scores to objects in the plurality of gaze boxes, and the gaze boxes further from the location in which the display device is pointed in the simulated environment receive lower scores than the gaze boxes closer to the location in which the display device is pointed in the simulated environment.

30. A non-transitory computer readable medium storing instructions that, when executed, cause a processor to:
access a representation of a simulated environment comprising a plurality of objects;
register a gaze location within the simulated environment,
construct a gaze box around the gaze location, wherein the gaze box is centered on a location in which the display device is pointed in the simulated environment,
recognize that a target object from the plurality of objects is within the gaze box, and
calculate a score for the target object in response to the target object being within the gaze box

31. The medium of claim 30, further storing instructions that, when executed, cause the processor to:
identify that the target object is associated with a survey question, and
cause the survey question to be displayed on the simulated environment or played to a user interacting with the simulated environment.

32. The medium of claim 31, further storing instructions that, when executed, cause the processor to:
register an answer to the survey question based on either or both of a direction in which the gaze is directed or a gesture identified based on the gaze location.

33. The medium of claim 31, further storing instructions that, when executed, cause the processor to:
determine an amount of attention given to the target object, and
triggering different survey questions depending on the amount of attention given to the target object.

34. The medium of claim 30, further storing instructions that, when executed, cause the processor to:
identify that a non-target object is not present in the gaze box, and
triggering a survey question based on a lack of gazing at the non-target object.

35. The medium of claim 30, further storing instructions that, when executed, cause the processor to:
determine one or more demographic characteristics of a user of the simulated environment, and
present different versions of the simulated environment depending on the one or more demographic characteristics.

36. The medium of claim 30, further storing instructions that, when executed, cause the processor to:
access a first version of the target object or a second version of the target object, wherein the first version of the target object and the second version of the target object differ from each other,
present the first version of the target object and the second version of the target object to different users,
record a first score for the first version of the target object and a second score for the second version of the target object, and
present the first score and the second score to a moderator of the simulated environment.
